(19) United States
(12) Patent Application Publication
(10) Pub. No.: US 2026/0225135 A1
(43) Pub. Date: Aug. 6, 2026

(54) HAND-HELD HIGH PRESSURE WASHER

(71) Applicant: JIANGSU DONGCHENG TOOLS TECHNOLOGY CO., LTD, Nantong (CN)

(72) Inventors: Shaoga PENG, Nantong (CN); Haibin HUANG, Nantong (CN); Peihua XUE, Nantong (CN)

(21) Appl. No.: 18/995,323

(22) PCT Filed: May 18, 2024
(86) PCT No.: PCT/CN2024/094091

§ 371 Date: Jan. 16, 2025

(30) Foreign Application Priority Data
Aug. 8, 2023 (CN) 202310997554.2

(51) Int. Cl. B08B 3/02; F16H 19/02

(52) U.S. Cl. CPC B08B 3/026; B08B 2203/0223; B08B 2203/027; F16H 19/02

(57) ABSTRACT

The present disclosure relates to a hand-held high pressure washer. The hand-held high pressure washer includes a pump unit, a motor assembly, a transmission assembly and a plunger, wherein the transmission assembly is provided with a case, the plunger is at least partially arranged in the case and extends into the pump unit, the transmission assembly drives the plunger to move in a reciprocating manner within the pump unit for pumping water. The transmission assembly includes a pressurizing mechanism abutting against the plunger, the pressurizing mechanism is located within the case, the pump unit is provided with a pressure chamber accommodating the plunger, the pressurizing mechanism and the pressure chamber are located at two ends of the plunger, the pressurizing mechanism has a first stage for storing energy and a second stage for releasing energy, in the first stage, the transmission assembly drives the plunger to store energy for the pressurizing mechanism; and in the second stage, the transmission assembly drives the plunger to pressurize the pressure chamber, and the pressurizing mechanism exerts an acting force on the plunger in a direction towards the pressure chamber. Through the present disclosure, the working efficiency of the hand-held high pressure washer can be greatly improved.

### TECHNICAL FIELD

The present disclosure relates to the field of electric tools, in particular to a hand-held high pressure washer configured to clean vehicles, courtyards, ground and the like.

### BACKGROUND

Washers are widely used in cleaning vehicles, courtyards, ground and the like, and the working principle is as follows: a motor assembly drives a plunger to move in a reciprocating manner, high pressure water is formed in the pump assembly and is sprayed outwards through a nozzle, in order to achieve a purpose of rinsing objects; a single-cylinder pump in the washer is characterized by simple structure and low cost, and is favored by users.

The working principle of a high pressure washer using the single-cylinder pump is as follows: with energy supplied from a power source, the motor assembly drives the plunger to move in a reciprocating manner within a pressure chamber of the single-cylinder pump; the plunger has a first stage of extruding the pressure chamber and a second stage of moving away from the pressure chamber, and only in the first stage, the plunger pressurizes water within the pressure chamber, i.e., in reciprocating movement of the plunger, half of the cycle does work within the pressure chamber, while the other half of the cycle does not do work in the pressure chamber, thereby leading to lower efficiency of the overall single-cylinder pump.

In addition, the output pressure and flow rate of the washer are directly affected by the motor assembly, if higher output pressure and flow rate are required, the requirement on the performance of the motor assembly is also higher, but this will undoubtedly increase the cost of the motor assembly, and will further lead to an increase in the cost of the whole machine.

### SUMMARY

In an aspect, the present disclosure provides a hand-held high pressure washer including a pump unit having a water inlet end and a water outlet end, a motor, a transmission assembly connected to the motor, and a plunger driven by the transmission assembly, wherein the transmission assembly is provided with a case, the plunger is at least partially arranged in the case and extends into the pump unit, the transmission assembly drives the plunger to move in a reciprocating manner within the pump unit for pumping water; the transmission assembly includes a pressurizing mechanism abutting against the plunger, the pressurizing mechanism is located within the case, the pump unit is provided with a pressure chamber accommodating the plunger, the pressurizing mechanism and the pressure chamber are located at two ends of the plunger, the pressurizing mechanism has a first stage for storing energy and a second stage for releasing energy, in the first stage, the transmission assembly drives the plunger to store energy for the pressurizing mechanism; and in the second stage, the transmission assembly drives the plunger to pressurize the pressure chamber and the pressurizing mechanism exerts an acting force on the plunger in a direction towards the pressure chamber.

In another aspect, the present disclosure provides a hand-held high pressure washer including a casing and a motor, a plunger, and a pump unit installed in the casing. The pump unit includes a water inlet end and a water outlet end connected to each other, and a pressure chamber located between the water inlet end and the water outlet end. The plunger extends into the pressure chamber. The motor drives the plunger to move in a reciprocating manner in the pressure chamber so as to pressurize external water flow entering from the water inlet end and then spray the water flow outwards from the water outlet end. The pump unit is a single-cylinder pump. The transmission assembly includes a pressurizing mechanism abutting against the plunger. The pressurizing mechanism and the pressure chamber are located at two ends of the plunger. The plunger moves linearly in a reciprocating manner along a first axis. The pressurization mechanism extends in a direction of the first axis and exerts a force on the plunger in the direction of the first axis.

In a further aspect, the present disclosure provides a hand-held high pressure washer including a casing and a motor, a transmission assembly, a plunger, and a pump unit installed in the casing. The pump unit includes a water inlet end and a water outlet end connected to each other, and a pressure chamber located between the water inlet end and the water outlet end. The transmission assembly is connected between the motor and the plunger. The plunger extends into the pressure chamber. The motor drives the plunger by the transmission assembly to move in a reciprocating manner in the pressure chamber so as to pressurize external water flow entering from the water inlet end and then spray the water flow outwards from the water outlet end. The plunger includes a first axis, the motor includes a second axis, the first axis is perpendicular to the second axis. The transmission assembly includes a pressurizing mechanism abutting against the plunger. The pressurizing mechanism and the pressure chamber are located at two ends of the plunger. The water inlet end and the motor are located on opposite sides of the first axis, and the pressurizing mechanism and the water outlet end are located on opposite sides of the second axis.

### BRIEF DESCRIPTION OF THE DRAWINGS

Specific embodiments of the present disclosure are described in further details below in combination with accompanying drawings.

FIG. 1 is a schematic diagram of a hand-held high pressure washer of the present disclosure.

FIG. 2 is a structural schematic diagram of a first angle of a drive module and a pump unit in a hand-held high pressure washer.

FIG. 3 is a structural schematic diagram of a second angle of the drive module and the pump unit in the hand-held high pressure washer.

FIG. 4 is a structural schematic diagram of a third angle of the drive module and the pump unit in the hand-held high pressure washer.

FIG. 5 is a structural schematic diagram of a fourth angle of the drive module and the pump unit in the hand-held high pressure washer.

FIG. 6 is a structural schematic diagram of a fifth angle of the drive module and the pump unit in the hand-held high pressure washer.

FIG. 7 is a schematic diagram showing connection between an inserting piece and a case in the drive module shown in FIG. 6.

FIG. 8 is a sectional view of the drive module and the pump unit when a pressurizing mechanism is in the first stage.

FIG. 9 is a sectional view of the drive module and the pump unit when the pressurizing mechanism is in the second stage.

FIG. 10 is a sectional view of another angle of the drive module and the pump unit.

FIG. 11 is a structural schematic diagram of a motor assembly in the drive module.

FIG. 12 is a structural schematic diagram of another angle of the motor assembly.

FIG. 13 is a sectional view of the motor assembly shown in FIG. 12.

FIG. 14 is a structural schematic diagram of a rotor assembly in the motor assembly.

FIG. 15 is a structural schematic diagram of another angle of the rotor assembly.

FIG. 16 is a sectional view of the rotor assembly.

FIG. 17 is an enlarged view of circle B2 in FIG. 15.

FIG. 18 is a structural schematic diagram of an end cap in the rotor assembly.

FIG. 19 is a structural schematic diagram of another angle of the end cap.

FIG. 20 is a structural schematic diagram of a magnetic steel frame in the rotor assembly.

FIG. 21 is an enlarged view of a glue overflow opening in the magnetic steel frame.

FIG. 22 is a structural schematic diagram of a stator core in a stator assembly.

FIG. 23 is a sectional view of stator teeth in the stator core.

FIG. 24 is an enlarged view of circle B3 in FIG. 23.

FIG. 25 is an enlarged view of circle B4 in FIG. 23.

FIG. 26 is an enlarged view of circle B1 in FIG. 9.

FIG. 27 is a structural schematic diagram of a toothed ring.

FIG. 28 is a structural schematic diagram of another angle of the toothed ring.

FIG. 29 is a structural schematic diagram of an output member.

FIG. 30 is a structural schematic diagram of the inserting piece.

FIG. 31 is a structural schematic diagram of another angle of the inserting piece.

FIG. 32 is a structural schematic diagram of a water inlet valve assembly when the water inlet valve assembly is in a first state.

FIG. 33 is a structural schematic diagram of the water inlet valve assembly when the water inlet valve assembly is in a second state.

FIG. 34 is a structural schematic diagram of the water inlet valve assembly when the water inlet valve assembly is in a third state.

FIG. 35 is a structural schematic diagram of a check valve assembly when the valve core is in a first position.

FIG. 36 is a structural schematic diagram of the check valve assembly when the valve core is in a second position.

FIG. 37 is an enlarged view of circle B5 in FIG. 35.

FIG. 38 is a structural schematic diagram of the valve core.

FIG. 39 is a structural schematic diagram of another angle of the valve core.

FIG. 40 is a structural schematic diagram of still another angle of the valve core.

FIG. 41 is a structural schematic diagram of a bracket.

FIG. 42 is a structural schematic diagram of another angle of the bracket.

FIG. 43 is a structural schematic diagram of still another angle of the bracket.

### REFERENCE NUMERALS IN THE FIGURES

| | | | |
|---|---|---|---|
| hand-held high pressure | 100 | battery pack | 200 |
| washer | | | |
| motor assembly | 1 | transmission assembly | 2 |
| fan assembly | 3 | pump unit | 4 |
| casing | 5 | check valve assembly | 6 |
| water inlet valve | 7 | pressurizing mechanism | 80 |
| assembly | | | |
| water inlet end | 10 | water outlet end | 20 |
| water inlet channel | 101 | water outlet channel | 102 |
| first sealing ring | 103 | second sealing ring | 104 |
| plunger | 88 | motor shaft | 11 |
| motor casing | 12 | stator assembly | 13 |
| rotor assembly | 14 | motor teeth | 15 |
| first bearing | 16 | second bearing | 17 |
| stator core | 131 | winding | 132 |
| sleeve | 1311 | stator teeth | 1312 |
| core body | 1313 | core casing | 1314 |
| first edge | 1315 | second edge | 1316 |
| first curvature | 1317 | second curvature | 1318 |
| arc-shaped portion | | arc-shaped portion | |
| first end point | 13171 | second end point | 13172 |
| first length | L1 | second length | L2 |
| end cap | 141 | end plate | 1411 |
| hood plate | 1412 | hole shaft | 1413 |
| cooling hole | 142 | first segment | 1421 |
| second segment | 1422 | intermediate segment | 1423 |
| magnetic steel frame | 143 | magnetic steel | 144 |
| annular body | 1431 | end face | 1432 |
| pillar | 1433 | glue overflow opening | 1434 |
| chamfer | 1435 | groove | 1436 |
| wind guiding surface | 1438 | heat dissipation space | 145 |
| first bearing chamber | 121 | second bearing chamber | 122 |
| elastic retaining ring | 18 | case | 21 |
| reducing mechanism | 22 | output member | 23 |
| planetary teeth | 221 | toothed ring | 222 |
| pin shaft | 34 | fastener | 223 |
| toothed ring body | 2221 | lip | 2222 |
| clamping column | 2223 | first case | 211 |
| second case | 212 | connecting column | 213 |
| first axis | A1 | second axis | A2 |
| third axis | A3 | intermediate section | 233 |
| first section | 231 | second section | 232 |
| third bearing | 224 | fourth bearing | 225 |
| first wall | 2331 | second wall | 2332 |
| through hole | 2333 | notch | 2334 |
| connecting hole | 2335 | frame body | 234 |
| eccentric portion | 235 | shelf | 2341 |
| first convex portion | 2342 | second convex portion | 2343 |
| air hole | 2344 | eccentric shaft | 2351 |
| annular portion | 2352 | slot | 2353 |
| guiding rod | 881 | mounting groove | 882 |
| fifth bearing | 885 | pump body | 41 |
| pressure chamber | 42 | inserting piece | 44 |
| tensioning member | 45 | U-shaped body | 451 |
| mounting arm | 452 | positioning opening | 453 |
| fastening bolt | 46 | mounting base | 214 |
| valve seat | 71 | cavity | 72 |
| first elastic member | 73 | valve ball | 74 |
| valve rod | 75 | supporting base | 76 |
| water inlet side | 781 | water outlet side | 782 |
| water flow direction | 783 | direction | 731 |
| guide pillar | 711 | supporting seat | 712 |
| inner cavity | 721 | base | 761 |
| first protruding block | 762 | first sealing member | 763 |
| second sealing member | 764 | gasket | 765 |
| valve body | 61 | water inlet | 62 |
| water outlet | 63 | water flow channel | 64 |
| bracket | 65 | valve core | 66 |
| second elastic member | 67 | head | 661 |
| rod portion | 662 | spiral feature | 663 |
| third sealing ring | 664 | accommodating cavity | 665 |
| guide head | 6631 | spiral portion | 6632 |
| proximal end | 6633 | distal end | 6634 |
| fourth axis | A4 | contact surface | 6611 |
| first wall surface | 6651 | second wall surface | 6652 |
| third wall surface | 6653 | buffer cavity | 6654 |
| bracket body | 651 | base body | 652 |
| water channel | 653 | second protruding block | 654 |
| bracket arm | 655 | hole portion | 6521 |
| bracket column | 6522 | cavity portion | 666 |
| base plate | 441 | clamping arm | 442 |
| step surface | 443 | opening | 444 |
| movable cavity | 215 | mounting opening | 216 |
| stop portion | 217 | reinforcing rib | 218 |

### DETAILED DESCRIPTION OF THE EMBODIMENTS

The present disclosure is described in further detail below in combination with accompanying drawings and embodiments.

The terms used in the present disclosure are merely for the purpose of describing particular embodiments, rather than limiting the present disclosure. For example, the following terms indicating orientation or positional relationship such as “upper”, “lower”, “front”, “rear”, “left” and “right” are merely based on the orientation or positional relationship shown in the accompanying drawings, and are merely used for facilitating description of the present disclosure and simplifying the description, rather than indicating or implying that the devices/elements referred to must have a particular orientation or be constructed and operated in a particular orientation, and therefore cannot be construed as a limitation of the present disclosure.

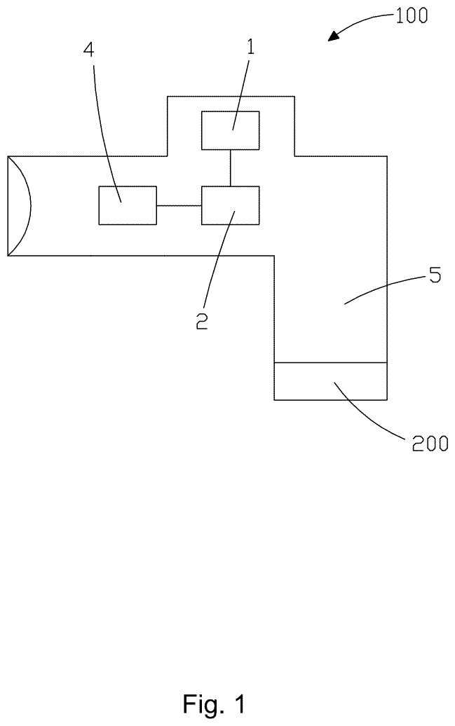

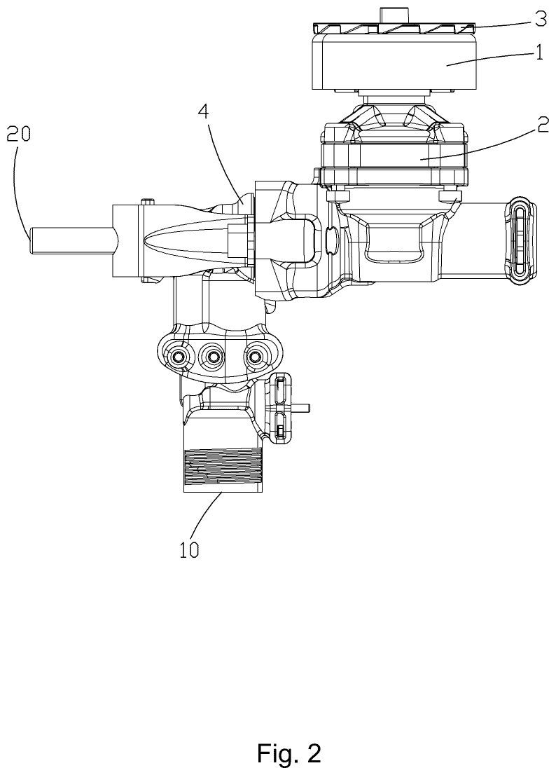

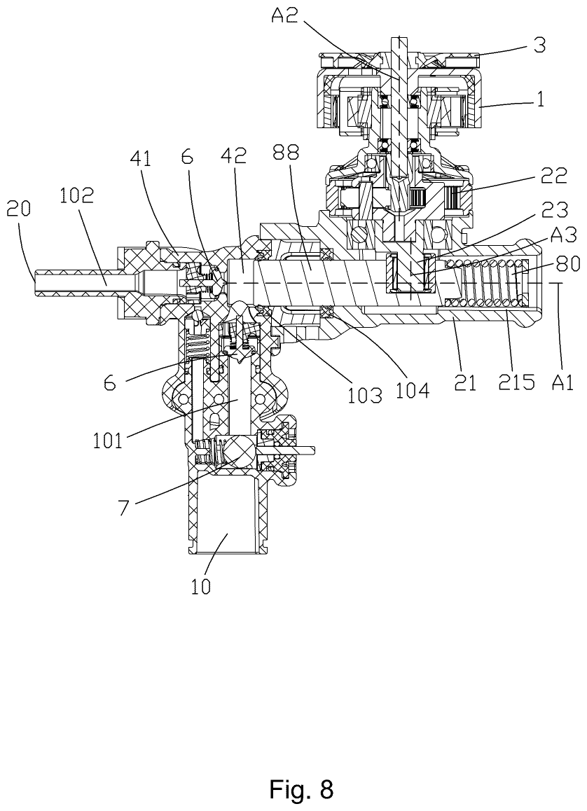

Referring to FIG. 1, FIG. 2 and FIG. 8, embodiments of the present disclosure relate to a hand-held high pressure washer 100, and the hand-held high pressure washer 100 is suitable for pressurizing external water flow and then spraying the water flow outwards for cleaning vehicles, courtyards, ground and the like. The hand-held high pressure washer 100 includes a casing 5, a motor assembly 1 mounted inside the casing 5, a transmission assembly 2 connected to the motor assembly 1, a plunger 88 driven by the transmission assembly 2, a battery pack 200 supplying energy for the motor assembly 1, and a pump unit 4 having a water inlet end 10 and a water outlet end 20, the water inlet end 10 is connected to the water outlet end 20, the plunger 88 extends into the pump unit 4, and the motor assembly 1 drives the plunger 88 via the transmission assembly 2 to move in a reciprocating manner within the pump unit 4, so as to pressurize the external water flow entering from the water inlet end 10 and then spray the water flow outwards from the water outlet end 20. Further, the motor assembly 1, the transmission assembly 2 and the plunger 88 form a drive module of the hand-held high pressure washer 100, the drive module is connected to the pump unit 4, and after the external water source enters from the water inlet end 10, the external water source is pressurized by the drive module and is then discharged from the water outlet end 20.

In the present embodiment, the above pump unit 4 is a single-cylinder pump driven by the plunger 88, and the pump unit 4 is arranged at one end of the plunger 88.

Referring to FIG. 1, the above casing 5 includes a main body portion accommodating the motor assembly 1, the transmission assembly 2 and the pump unit 4, and a gripping portion extending from an end of the main body portion, the main body portion and the gripping portion are formed as an entirety, and the battery pack 200 is detachably mounted to the gripping portion.

Optionally, the nominal voltage of the above battery pack 200 may be greater than or equal to 10 V and less than or equal to 20 V, for example, the nominal voltage of the battery pack 200 may be 12 V, 18 V, 20 V, etc.; optionally, the nominal voltage of the battery pack 200 may be greater than or equal to 20 V and less than or equal to 100 V, for example, the nominal voltage of the battery pack 200 may be 24 V, 40 V, 56 V, 80 V, etc.

Optionally, the number of cell units contained in one cell unit group in the above battery pack 200 may be greater than or equal to 3 and less than or equal to 5, for example, the number of cell units contained in one cell unit group may be 3, 4 or 5. Optionally, the number of cell units contained in a cell unit group in the battery pack 200 may be greater than or equal to 6 and less than or equal to 25, for example, the number of cell units contained in one cell unit group may be 6, 10, 14, 20 and the like.

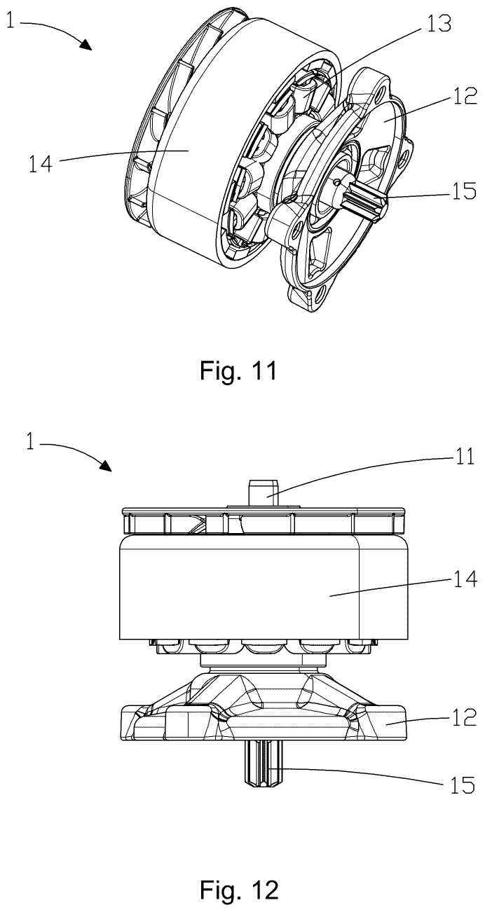

Referring to FIG. 11 to FIG. 13, the above motor assembly 1 includes a motor casing 12, a stator assembly 13 mounted on the motor casing 12, a motor shaft 11 movably connected to the motor casing 12, a rotor assembly 14 fixed on the motor shaft 11, a motor tooth 15 mounted on the motor shaft 11, a bearing assembly supporting the motor shaft 11, and a fan assembly 3 mounted on the motor shaft 11, wherein the motor assembly 1 is an outer-rotor brushless motor, the rotor assembly 14 is sleeved on the outer side of the stator assembly 13, the rotor assembly 14 and the motor teeth 15 are mounted on two ends of the motor shaft 11, respectively, the fan assembly 3 is arranged to be adjacent to the rotor assembly 14, and when the motor shaft 11 rotates, the motor shaft 11 drives the rotor assembly 14 and the fan assembly 3 to rotate at the same time.

Further, the airflow generated by rotation of the above fan assembly 3 flows through the rotor assembly 14 and the stator assembly 13 to cool the rotor assembly 14 and the stator assembly 13. Still further, the rotor assembly 14 includes an end cap 141 connected to the motor shaft 11 and a cooling hole 142 extending through the end cap 141, and the cooling hole 142 is arranged between the stator assembly 13 and the fan assembly 3, such that the airflow generated by rotation of the fan assembly 3 flows through the interior of the rotor assembly 14 and efficiently cools the area in which the stator assembly 13 is located.

In the present embodiment, the above bearing assembly is arranged between the rotor assembly 14 and the motor teeth 15, and the bearing assembly includes a first bearing 16 close to the rotor assembly 14 and a second bearing 17 close to the motor teeth 15, and correspondingly, the motor casing 12 includes a first bearing chamber 121 in which the first bearing 16 is mounted, and a second bearing chamber 122 in which the second bearing 17 is mounted, and the first bearing chamber 121 and the second bearing chamber 122 are integrally formed on the motor casing 12.

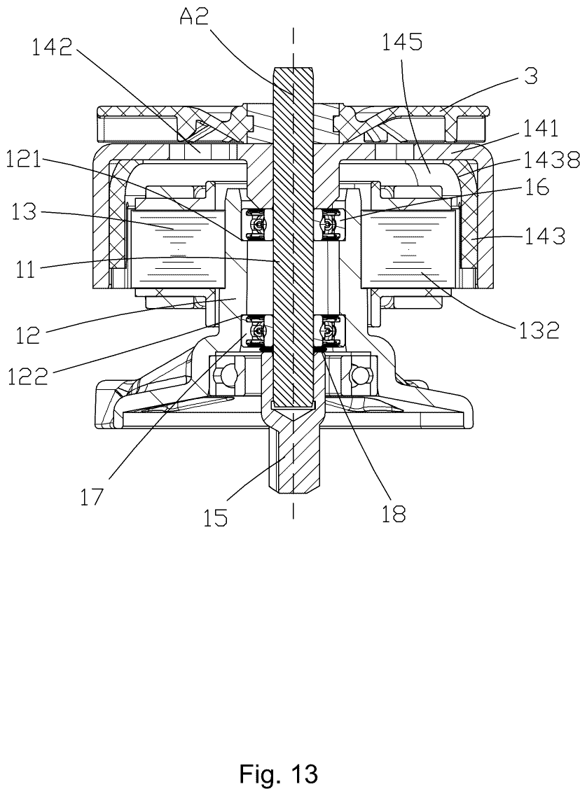

Referring to FIG. 13, the above bearing assembly is in loose fit with the motor shaft 11, and the rotor assembly 14, the motor teeth 15 and the motor shaft 11 are in tight fit; the motor assembly 1 includes an elastic retaining ring 18 arranged between the bearing assembly and the motor teeth 15, and the elastic retaining ring 18 fills the gap between the bearing assembly and the motor teeth 15. By setting the elastic retaining ring 18 on the outer side of the motor shaft 11, the elastic retaining ring 18 is configured to compensate for tolerances in the assembly process of the motor assembly 1, thereby avoiding axial endplay of the motor shaft 11, and the elastic retaining ring 18 has a certain degree of elasticity, and the bearing assembly is not easily damaged in the press-fitting process.

Further, the above rotor assembly 14 abuts against the inner ring of the first bearing 16, and the motor teeth 15 abut against the elastic retaining ring 18, and the elastic retaining ring 18 abuts against the inner ring of the second bearing 17.

Alternatively, the above elastic retaining ring 18 may also be arranged between the bearing assembly and the rotor assembly 14, and the elastic retaining ring 18 fills the gap between the bearing assembly and the rotor assembly 14.

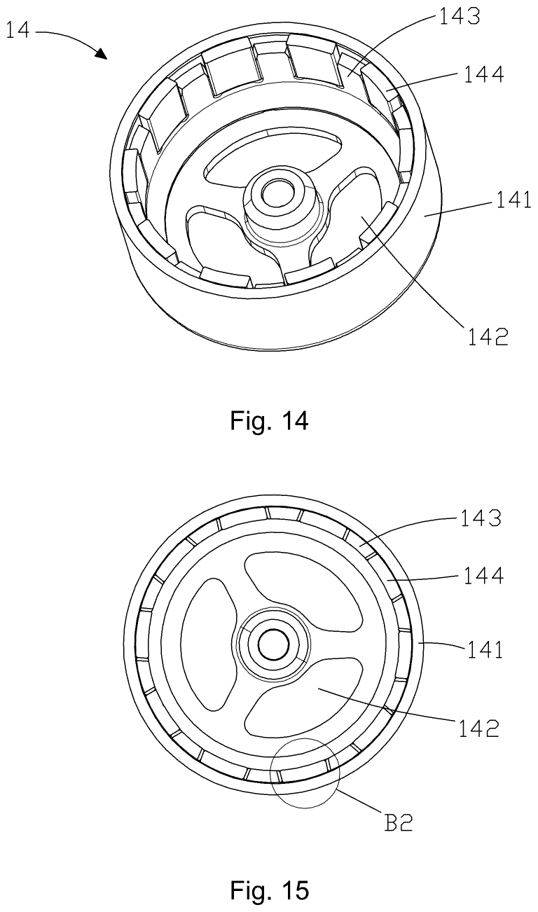

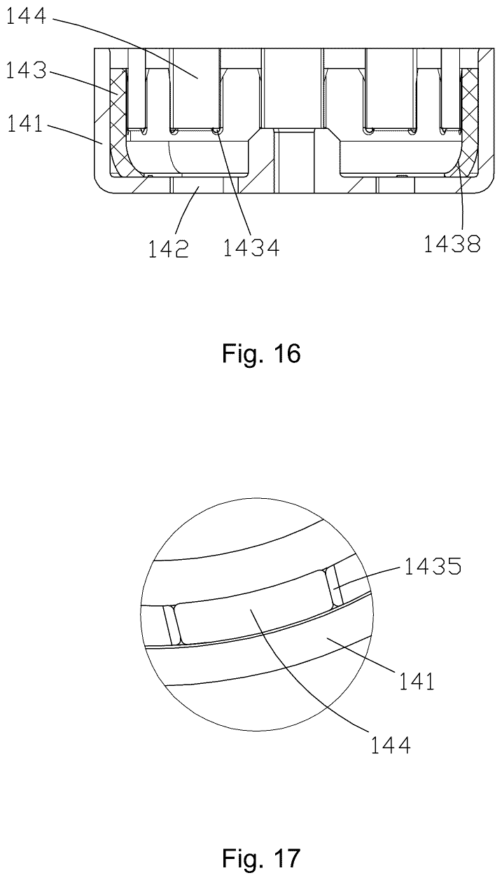

Referring to FIG. 14 to FIG. 16, the above rotor assembly 14 includes an end cap 141 fixed to the motor shaft 11, a cooling hole 142 extending through the end cap 141, and a magnetic steel frame 143 arranged on the inner side of the end cap 141, and a magnetic steel 144 mounted on the magnetic steel frame 143, the magnetic steel frame 143 is arranged between the end cap 141 and the stator assembly 13, the magnetic steel 144 is fixedly mounted to the magnetic steel frame 143 by means of glue, and the magnetic steel frame 143 and the magnetic steel 144 are attached to the inner wall of the end cap 141.

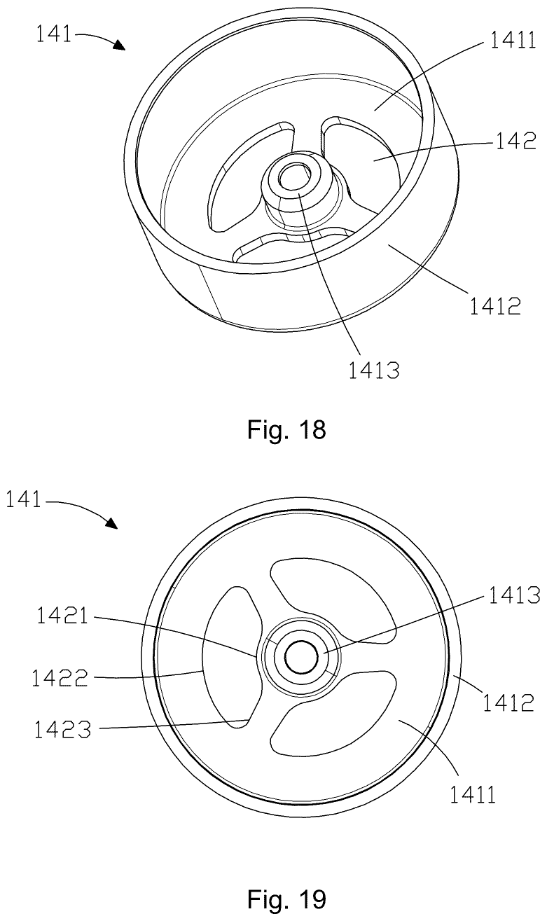

As shown in combination with FIG. 18 and FIG. 19, the above end cap 141 includes an end plate 1411, a hood plate 1412 protruding from the circumferential side of the end plate 1411, and a hole shaft 1413 connected to the end plate 1411, the hole shaft 1413 is arranged in the middle of the end plate 1411, and the motor shaft 11 extends through the hole shaft 1413, and the end cap 141 is fixed to the motor shaft 11 via the hole shaft 1413.

In the present embodiment, the above cooling holes 142 are formed in the end plate 1411, and the cooling holes 142 are distributed around the circumferential side of the hole shaft 1413.

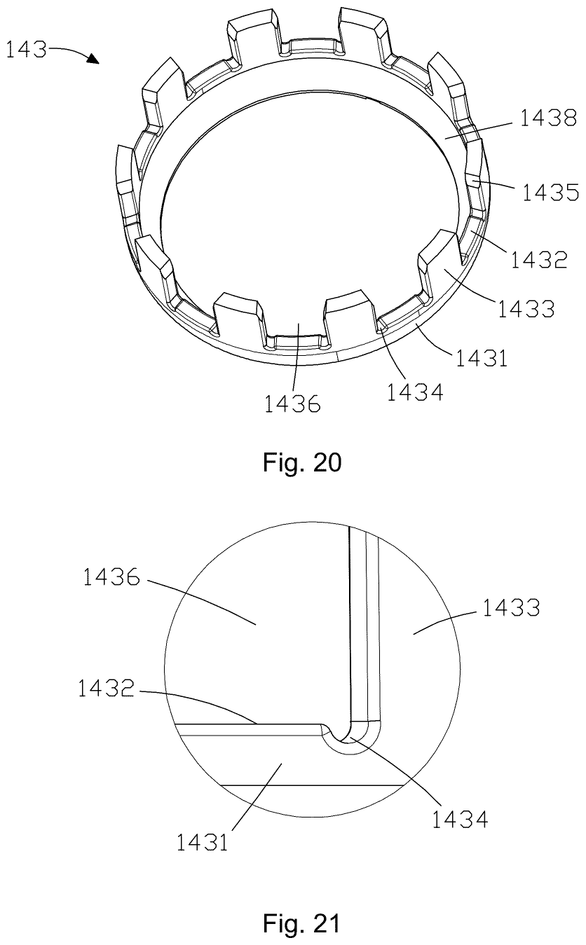

As shown in combination with FIG. 20, the above magnetic steel frame 143 includes an annular body 1431, a plurality of pillars 1433 protruding outwards from an end face 1432 of the annular body 1431, and a wind guiding surface 1438 arranged on the inner side of the annular body 1431, wherein the plurality of pillars 1433 are arranged at intervals and a groove 1436 is formed between two adjacent pillars 1433, the magnetic steel 144 is arranged within the groove 1436, and the magnetic steel 144 extends beyond the end of the pillar 1433. The wind guiding surface 1438 is configured to blow the airflow generated by rotation of the fan assembly 3 to the stator assembly 13 via the wind guiding surface 1438. By arranging the wind guiding surface 1438 on the inner side of the annular body 1431 of the magnetic steel frame 143, the cooled airflow is blown to the stator assembly 13 via the wind guiding surface 1438 and cools the stator assembly 13, thereby greatly improving the heat dissipation effect of the motor assembly 1.

In the present embodiment, the above wind guiding surface 1438 is an arc-shaped surface extending from the pillar 1433 towards the cooling hole 142, and the wind guiding surface 1438 at least partially extends between the cooling hole 142 and the stator assembly 13.

Further, the above motor assembly 1 has a second axis A2, and in the direction of the second axis A2, the end plate 1411 and the stator assembly 13 are spaced apart to form a heat dissipation space 145, and the heat dissipation space 145 allows circulation of cooled airflow to improve the heat dissipation effect of the motor assembly 1.

Further, the above heat dissipation space 145 extends through the stator assembly 13.

Referring to FIG. 19, the above cooling hole 142 includes a first segment 1421 and a second segment 1422 extending along the periphery of the hole shaft 1413 and spaced apart from each other, and an intermediate segment 1423 connected between the first segment 1421 and the second segment 1422, wherein the first segment 1421, the second segment 1422, and the intermediate segment 1423 enclose each other to form the cooling holes 142.

In the present embodiment, a plurality of cooling holes 142 are formed, and the plurality of cooling holes 142 are spaced apart around the hole shaft 1413. Further, the projection of the cooling hole 142 on the end plate 1411 is at least partially overlapped with the projection of the stator assembly 13 on the end plate 1411, such that the cooled airflow flows through the stator assembly 13 to improve the heat dissipation effect. Still further, the projection of the cooling hole 142 on the end plate 1411 is overlapped with the projection of the stator assembly 13 on the end plate 1411 by at least 60 percent, to further improve the overall heat dissipation effect.

In the present embodiment, the above first segment 1421 is arranged adjacent to the hole shaft 1413, such that the cooling hole 142 covers the stator assembly 13 as large as possible to improve the heat dissipation effect.

Referring to FIG. 20 and FIG. 21, the above magnetic steel frame 143 further includes a glue overflow opening 1434 recessed inwards from an end face 1432 of the annular body 1431, the glue overflow opening 1434 is arranged at an end of the magnetic steel 144, and the glue overflow opening 1434 is an arc-shaped recess, and the glue overflow opening 1434 is configured to accommodate glue. When the magnetic steel 144 is mounted to the magnetic steel frame 143, the glue overflow opening 1434 can store excess glue, thereby ensuring consistency of mounting fit of the magnetic steel 144, and making the height and magnetic field distribution of the magnetic steel 144 more uniform; furthermore, the stored glue will be uniformly distributed around the end cap 141 and the magnetic steel frame 143 after the glue is cured, and the cured glue can also play a role of buffering and absorbing vibration during operation of the motor assembly 1, to prolong the service life of the motor assembly 1.

In the present embodiment, the above glue overflow opening 1434 is arranged at the connecting position between the pillar 1433 and the end face 1432, i.e., the glue overflow opening 1434 is arranged at the corner of the groove 1436, and further, the glue overflow opening 1434 is connected to the groove 1436.

As shown in combination with FIG. 17, a chamfer 1435 is arranged at the end of the above pillar 1433, such that a gap is reserved between the end cap 141, the magnetic steel frame 143 and the magnetic steel 144.

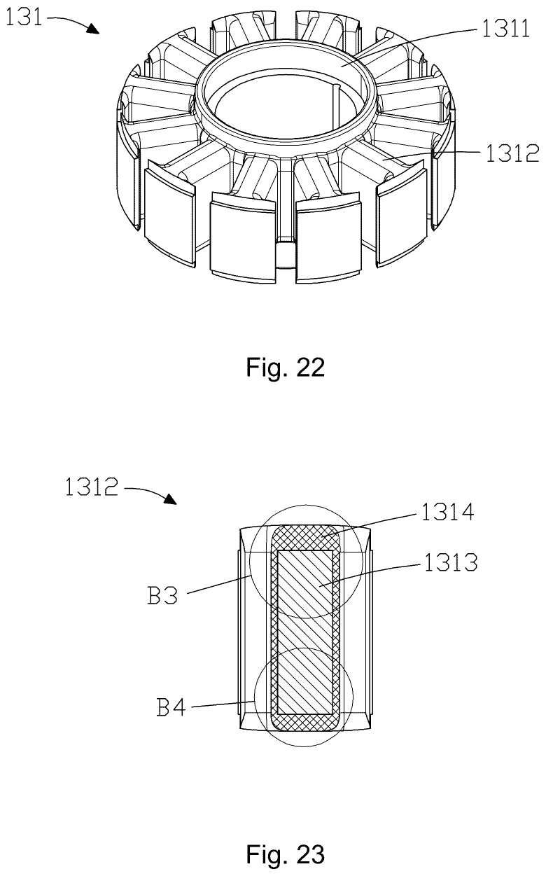

Referring to FIG. 13, FIG. 22 and FIG. 23, the above stator assembly 13 includes a stator core 131 and a winding 132 wrapping around the stator core 131, the stator core 131 includes a sleeve 1311 connected to the motor casing 12 and stator teeth 1312 protruding radially outwards from the periphery of the sleeve 1311, and the winding 132 wraps around the stator teeth 1312.

In the present embodiment, the above stator teeth 1312 include a core body 1313 and a core casing 1314 wrapping the core body 1313, wherein the core casing 1314 has a pair of first edges 1315 arranged to be parallel to each other, a pair of second edges 1316 arranged to be parallel to each other, and curvature arc-shaped portions 1317, 1318 connected between the first edges 1315 and the second edges 1316, and the winding 132 is attached to the curvature arc-shaped portions 1317, 1318. The curvature arc-shaped portion can effectively reduce the problem of wire injury caused by stress concentration at the corners of the stator teeth 1312, meanwhile, the winding 132 and the stator teeth 1312 fit more closely to each other to improve consistency in height; in addition, the curvature arc-shaped portion reduces the overall height and space of the winding 132 after wire wrapping, thereby being conducive to reducing length of the enameled wire of the winding 132, and reducing the manufacturing cost of the motor assembly 1.

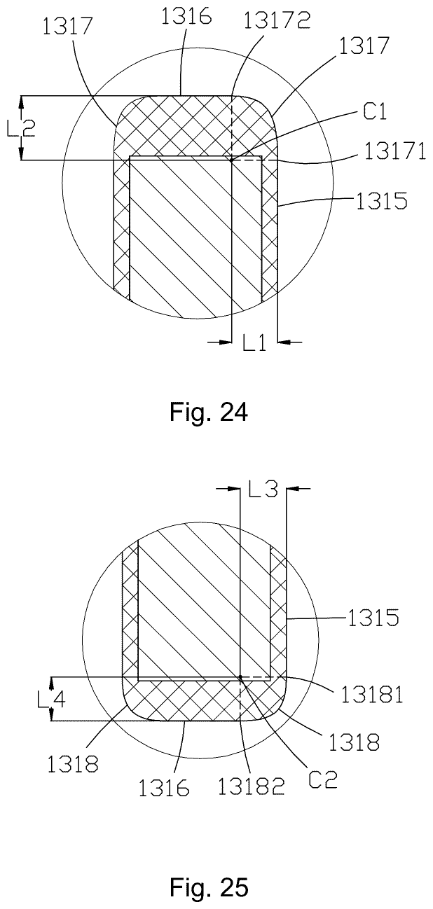

Referring to FIG. 24 and FIG. 25, the above curvature arc-shaped portions 1317, 1318 include a first curvature arc-shaped portion 1317 and a second curvature arc-shaped portion 1318 arranged at two sides of the first edge 1315, respectively, and the first edge 1315, the second edge 1316, the first curvature arc-shaped portion 1317, and the second curvature arc-shaped portion 1318 are all arranged on the periphery of the core casing 1314.

Further, the number of the above first curvature arc-shaped portion 1317 and the second curvature arc-shaped portion 1318 is two, and the first curvature arc-shaped portion 1317 and the second curvature arc-shaped portion 1318 are distributed at four corners of the core casing 1314.

Still further, two identical curvature arc-shaped portions are arranged at two ends of the second edge 1316, i.e., two first curvature arc-shaped portions 1317 are arranged at two ends of the second edge 1316 on an upper side, and two second curvature arc-shaped portions 1318 are arranged at two ends of the second edge 1316 on a lower side.

Still further, both the above first curvature arc-shaped portion 1317 and the second curvature arc-shaped portion 1318 are elliptical in shape.

Referring to FIG. 24, the above first curvature arc-shaped portion 1317 has a first end point 13171, a second end point 13172, and a centre C1, wherein the center C1 is apart from the first end point 13171 by a first length L1, the centre C1 is apart from the second end point 13172 by a second length L2, and the first length L1 is different from the second length L2. Correspondingly, the second curvature arc-shaped portion 1318 also has two end points 13181, 13182 and a centre C2, the center C2 is apart from the end point 13181 by a length L3, the centre C2 is apart from the end point 13182 by a length L4, and the length L3 is also different from the length L4.

Further, the above second length L2 is also different from the length L4, i.e., the first curvature arc-shaped portion 1317 and the second curvature arc-shaped portion 1318 have different shapes.

In the present embodiment, the airflow generated by rotation of the above fan assembly 3 passes through the cooling hole 142 and cools the winding 132.

Referring to FIG. 2, FIG. 8 and FIG. 13, the above transmission assembly 2 includes a case 21, a reducing mechanism 22 connected to the motor assembly 1 and an output member 23 connected to the reducing mechanism 22, wherein the motor shaft 11 of the motor assembly 1 extends into the case 21, the motor teeth 15 on the motor shaft 11 are engaged in the reducing mechanism 22, and the output member 23 is connected to the plunger 88 and drives the plunger 88 to move in a reciprocating manner, and further, the plunger 88 is at least partially arranged within the case 21 and extends into the pump unit 4 to pressurize water within the pump unit 4.

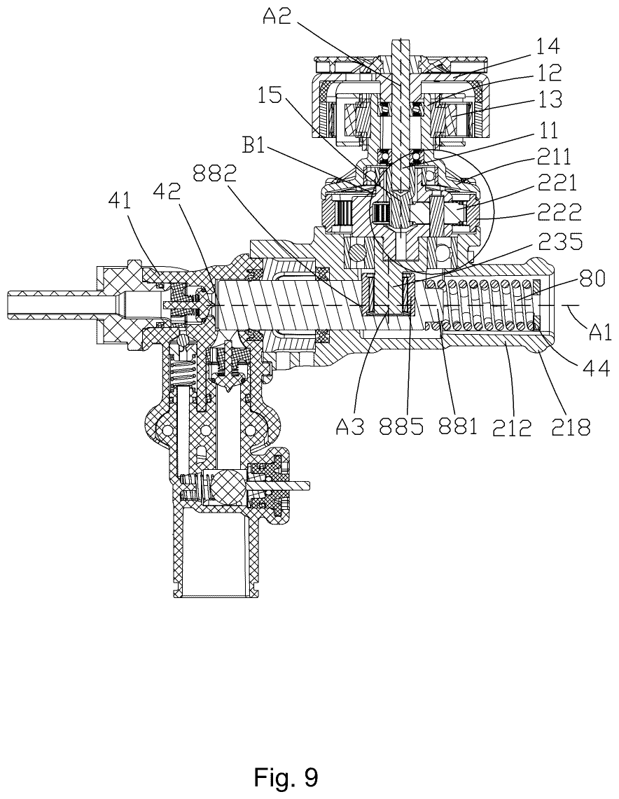

As shown in combination with FIG. 9, the above case 21 and the motor casing 12 are integrated, and the motor casing 12 extends between the stator assembly 13 and the motor shaft 11.

In the present embodiment, the above reducing mechanism 22 includes planetary teeth 221 engaged in the motor teeth 15 of the motor assembly 1, a toothed ring 222 engaged in the planetary teeth 221, and a bearing supporting an output member 23, and the output member 23 is connected to the planetary teeth 221 via a pin shaft 34.

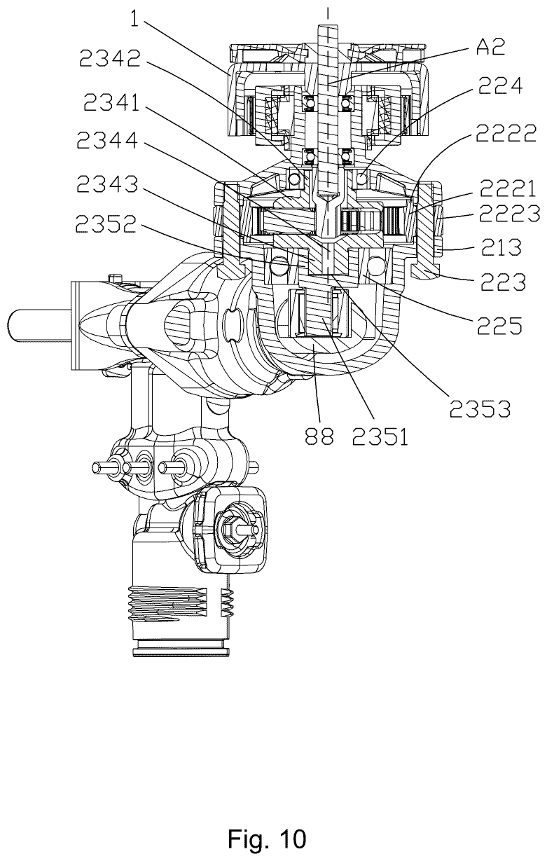

Referring to FIG. 10, a fastener 223 extends through the case 21 and the toothed ring 222 to lock the case 21 and the toothed ring 222.

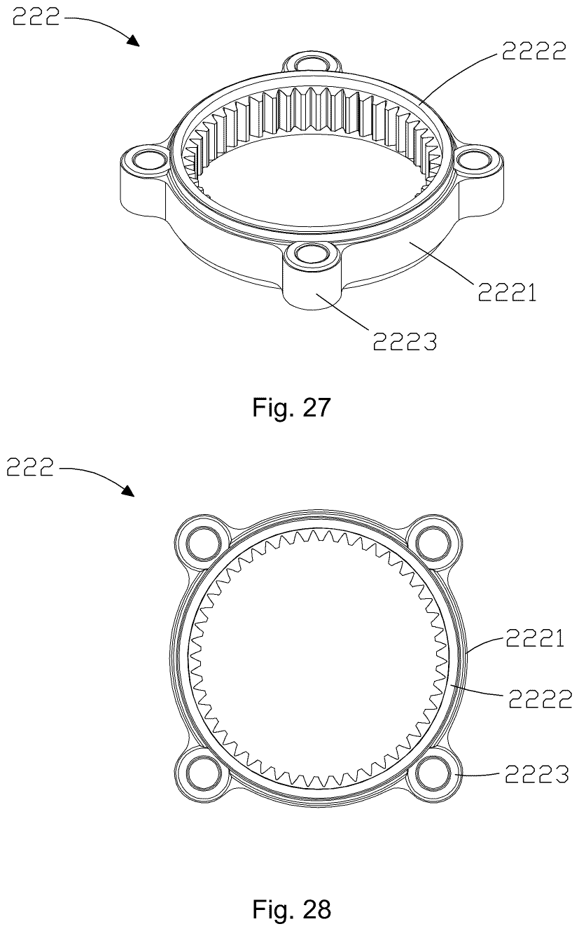

As shown in combination with FIG. 27 and FIG. 28, the above toothed ring 222 includes a toothed ring body 2221 engaged in the planetary teeth 221, a lip 2222 protruding axially from an end face of the toothed ring body 2221, and a clamping column 2223 protruding radially from the periphery of the toothed ring body 2221, wherein the lip 2222 abuts against and is tightly attached to the inner side of the case 21, and the fastener 223 extends through the case 21 and the clamping column 2223, to fix the case 21 and the toothed ring 222.

Further, the above case 21 includes a first case 211 and a second case 212 which are separated, the toothed ring 222 is sandwiched between the first case 211 and the second case 212, and the fastener 223 extends through the second case 212, the toothed ring 222 and the first case 211, so as to lock the case 21 and the toothed ring 222. By at least partially exposing the toothed ring 222 outside the case 21, heat generated during engagement of the planetary teeth 221 and the toothed ring 222 can be effectively radiated outwards through the toothed ring 222, so as to improve the heat dissipation effect of the transmission assembly 2.

In the present embodiment, the number of the above lip 2222 is two, and the two lips 2222 abut against the inner walls of the first case 211 and the second case 212, respectively; moreover, the case 21 also includes a connecting column 213 protruding from the periphery, and the fastener 223 extends through the connecting column 213 and the clamping column 2223, to fix the case 21 and the toothed ring 222 together. Further, the output member 23 is an eccentric member, the force of the motor assembly 1 is transmitted to the output member 23 via the reducing mechanism 22, and the output member 23 then drives the plunger 88 to move in a reciprocating manner; moreover, the plunger 88 has a first axis A1, and the first axis A1 is perpendicular to the second axis A2. During high-speed reciprocating movement of the plunger 88, the toothed ring 222 will be subjected to a large load and impact, and the toothed ring 222 is sandwiched between the first case 211 and the second case 212, the two lips 2222 respectively abut against the inner walls of the first case 211 and the second case 212, and the surface of the clamping column 2223 is tightly attached to the surface of the connecting column 213, and then the second case 212, the toothed ring 222 and the first case 211 are locked together by a fastener 223, and the toothed ring 222 is effectively fixed and is not easily loosened.

Referring to FIG. 8 and FIG. 9, the first axis A1 extends in a left-right direction, and the second axis A2 extends in an up-down direction. The motor assembly 1 is located on an upper side of the first axis A1, and the water inlet end 10 is located on a lower side of the first axis A1. The second axis A2 extends through the first axis A1.

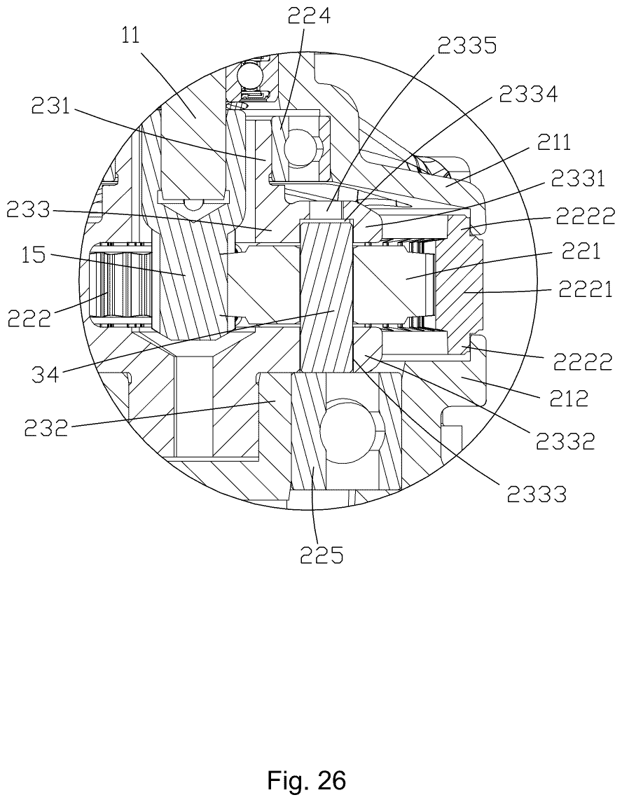

Referring to FIG. 26, the above output member 23 includes an intermediate section 233 accommodating the planetary teeth 221, a first section 231 and a second section 232 connected to two sides of the intermediate section 233, respectively, and a pin shaft 34 mounting the planetary teeth 221 to the intermediate section 233, and the bearings include a third bearing 224 supporting the first section 231 and a fourth bearing 225 supporting the second section 232, and the pin shaft 34 is arranged between the third bearing 224 and the fourth bearing 225. The intermediate section 233 includes a first wall 2331 connected to the first section 231, a second wall 2332 connected to the second section 232, a through hole 2333 extending through the second wall 2332, a notch 2334 recessed from a wall surface of the first wall 331, and a connecting hole 2335 connected to the notch 2334, and one end of the pin shaft 34 extends through the through hole 2333 and abuts against the inner ring of the fourth bearing 225, and the other end of the pin shaft 34 extends into the notch 2334. By limiting one end of the pin shaft 34 by the inner ring of the bearing 225 and by limiting the other end by the notch 2334 of the intermediate section 233, the entire pin shaft 34 can be positioned with no need of setting an additional stop gasket, the structure is clever and axial endplay of the pin shaft 34 is effectively prevented; in addition, during movement of the planetary teeth 221, the pin shaft 34, the output member 23 and the bearing 225 are driven to move simultaneously with small friction loss and high transmission efficiency.

In the present embodiment, the inner diameter of the above notch 2334 and the inner diameter of the through hole 2333 are the same, and the diameter of the connecting hole 2335 is less than the diameters of the notch 2334 and the pin shaft 34.

In the present embodiment, the above third bearing 224 is mounted in the first case 211 and the fourth bearing 225 is mounted in the second case 212.

In the present embodiment, the number of the above planetary teeth 221 is multiple, and the planetary teeth 221 are arranged between the first wall 2331 and the second wall 2332, and the number of the pin shafts 34 is also multiple and the multiple pin shafts 34 penetrate through the corresponding planetary teeth 221, respectively.

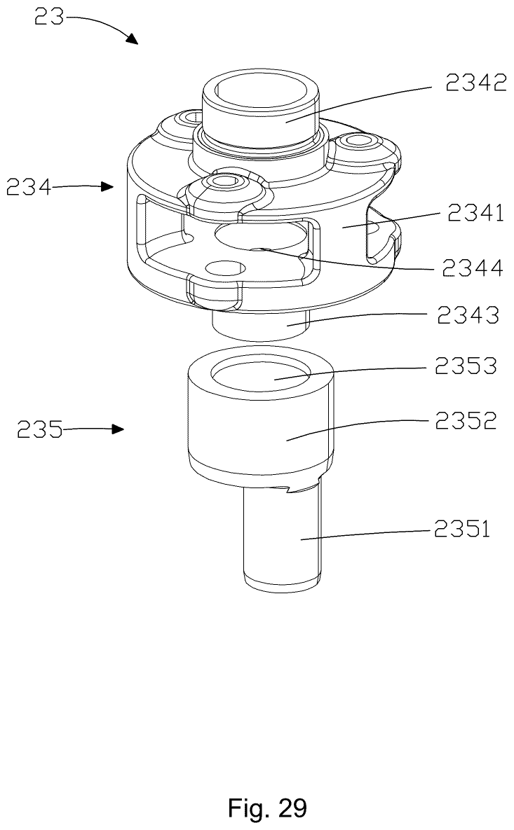

Referring to FIG. 29, the above output member 23 is a split member and includes a frame body 234 connected to the reducing mechanism 22 and an eccentric portion 235 connected to the plunger 88, wherein the eccentric portion 235 is fixedly connected to the frame body 234, and the frame body 234 and the eccentric portion 235 are of a split structure, and the two are made of different materials, respectively.

Specifically, the above eccentric portion 235 needs to bear a greater force than the frame body 234, and the requirement on rigidity of the eccentric portion 235 is higher than the requirement on rigidity of the frame body 234, so the material of the eccentric portion 235 is superior to the material of the frame body 234, and correspondingly, the manufacturing cost of the eccentric portion 235 is also higher than the manufacturing cost of the frame body 234. In this way, under the premise of meeting the transmission requirements, the eccentric portion 235 is manufactured from a better material with higher cost, while the frame body 234 may be manufactured from a slightly worse material at a lower cost, thereby reducing the manufacturing cost of the entire output member 23.

Referring to FIG. 10, the above third bearing 224 is supported on the frame body 234 and the fourth bearing 225 is supported on the eccentric portion 235.

As shown in combination with FIG. 29, the above frame body 234 includes a shelf 2341 for accommodating the planetary teeth 221, a first convex portion 2342 protruding towards the motor assembly 1 from one end face of the shelf 2341, and a second convex portion 2343 protruding towards the eccentric portion 235 from the other end face of the shelf 2341, and the eccentric portion 235 includes an eccentric shaft 2351 connected to the plunger 88 and an annular portion 2352 fixedly connected to the eccentric shaft 2351, and the second convex portion 2343 is fixed to the annular portion 2352.

Further, the above eccentric portion 235 further includes a slot 2353 recessed inwards from the end face of the annular portion 2352, and the second convex portion 2343 is fixedly clamped within the slot 2353.

In the present embodiment, the above third bearing 224 supports the first convex portion 2342 and the fourth bearing 225 supports the annular portion 2352.

In the present embodiment, the above shelf 2341 forms the intermediate section 233, the first convex portion 2342 forms the first section 231, and the second convex portion 2343 and the annular portion 2352 together form the second section 232.

Referring to FIG. 10 and FIG. 29, the above frame body 234 is also provided with an air hole 2344 which extends through the second convex portion 2343, the air hole 2344 is connected to the interior of the slot 2353 on one side and is connected to the interior of the shelf 2341 on the other side. Since the eccentric portion 235 is in tight fit with the frame body 234, the gas inside the slot 2353 can be discharged outwards through the air hole 2344 during the process of mounting the second convex portion 2343 to the annular portion 2352, such that the assembly of the eccentric portion 235 and the frame body 234 is more convenient and more effective.

In the present embodiment, in the direction of the second axis A2, the above second convex portion 2343, the fourth bearing 225 and the annular portion 2352 are at least partially overlapped; moreover, in the direction of the second axis A2, the extension length of the second convex portion 2343 is less than the extension length of the fourth bearing 225, and the extension length of the fourth bearing 225 is less than the extension length of the annular portion 2352, such that the eccentric portion 235 and the frame body 234 can be assembled better.

In the present embodiment, the above plunger 88 has a recessed mounting groove 882 and a fifth bearing 885 arranged in the mounting groove 882, and the eccentric shaft 2351 of the eccentric portion 235 protrudes into the mounting groove 882 and is mounted on the fifth bearing 885 to drive the plunger 88 to move for pumping water. Still further, the eccentric shaft 2351 of the above eccentric portion 235 has a third axis A3, and the third axis A3 and the second axis A2 are not co-linear.

Alternatively, the above output member 23 may also be an integrated member.

In the present embodiment, the third axis A3 extends through the first axis A1.

Referring to FIG. 8 and FIG. 9 again, the above transmission assembly 2 further includes a pressurizing mechanism 80 abutting against the plunger 88, the pressurizing mechanism 80 is located in the case 21, the pump unit 4 is provided with a pressure chamber 42 accommodating the plunger 88, and the pressurizing mechanism 80 and the pressure chamber 42 are located at two ends of the plunger 88, respectively, and the pressurizing mechanism 80 has a first stage for storing energy and a second stage for releasing energy, and in the first stage, the transmission assembly 2 drives the plunger 88 to store energy for the pressurizing mechanism 80; and in the second stage, the transmission assembly 2 drives the plunger 88 to pressurize water in the pressure chamber 42, while the pressurizing mechanism 80 exerts an acting force on the plunger 88 in a direction towards the pressure chamber 42. The pump unit 4 is a single-cylinder pump, and the characteristics of the single-cylinder pump determine that the plunger 88 only does work (i.e., pressurizing the water in the pressure chamber 42) for half of the cycle, therefore, the efficiency is low; in the present embodiment, a pressurizing mechanism 80 is arranged at the end of the plunger 88 away from the pump unit 4, such that the plunger 88 stores energy for the pressurizing mechanism 80 in the half cycle when the plunger 88 does not do work, and the stored energy is released to the plunger 88 again in the half cycle when the plunger 88 does work, thereby greatly increasing the working efficiency of the hand-held high pressure washer 100; in addition, the pressurizing mechanism 80 can compensate for the torque of the plunger 88, such that higher output pressure and flow rate can also be obtained even when the performance of the motor assembly 1 is not high, thereby effectively reducing the cost of the whole machine.

In the present embodiment, the above plunger 88 includes a guiding rod 881 protruding from the end towards the pressurizing mechanism 80, the transmission assembly 2 includes an inserting piece 44 mounted in the case 21, the pressurizing mechanism 80 is a spring, and one end of the pressurizing mechanism 80 is sleeved on the guiding rod 881 and the other end presses against the inserting piece 44.

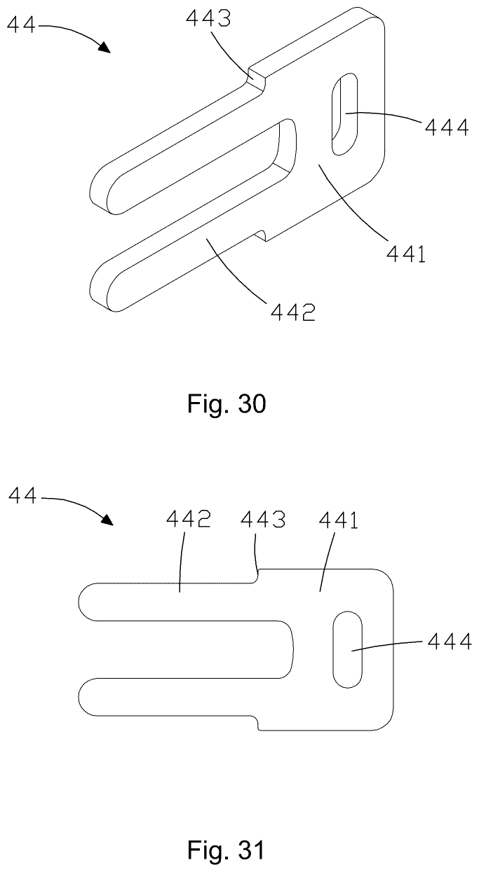

Referring to FIG. 30 and FIG. 31 again, the above inserting piece 44 includes a base plate 441, a clamping arm 442 connected to the base plate 441, a step surface 443 arranged at the connecting position between the base plate 441 and the clamping arm 442, and an opening 444 extending through the base plate 441, wherein the clamping arm 442 is U-shaped, and the two arms of the clamping arm 442 abut against the pressurizing mechanism 80, and the inserting piece 44 is integrated.

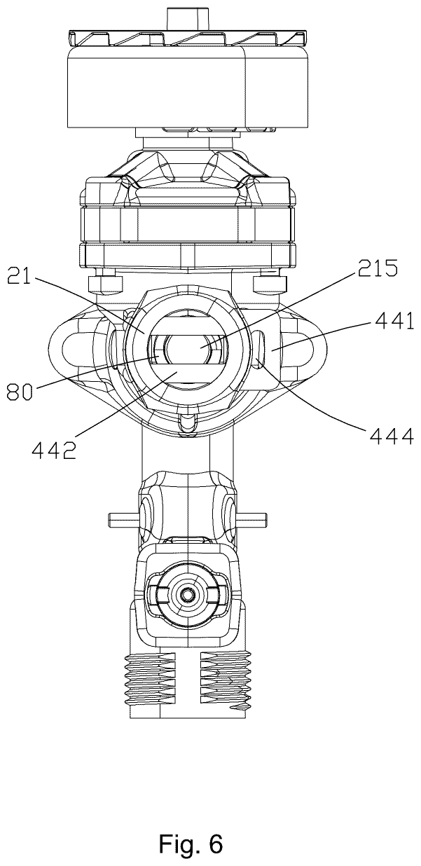

As shown in combination with FIG. 6, the above opening 444 is at least partially exposed to the outer side of the case 21, so as to facilitate mounting and dismounting of the inserting piece 44.

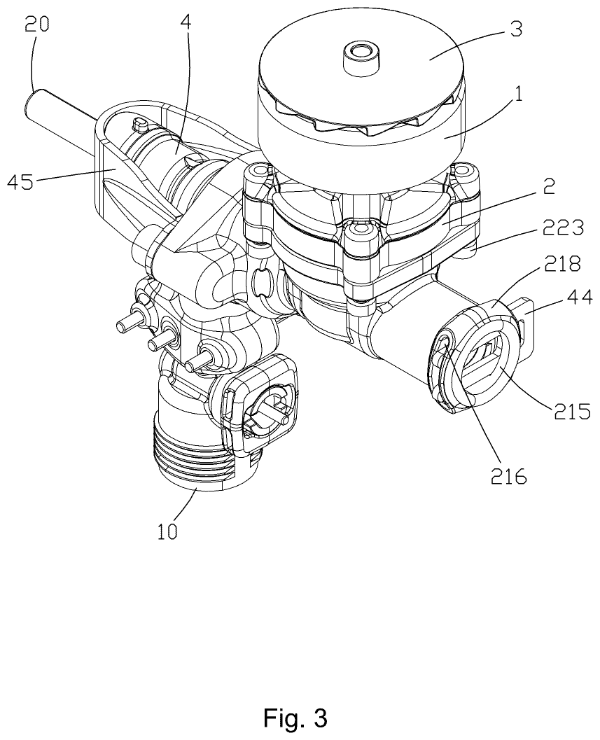

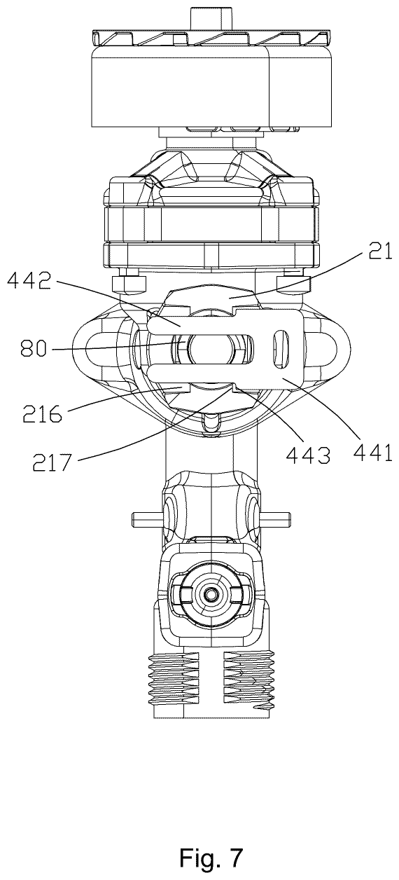

As shown in combination with FIG. 3 and FIG. 7, the above step surface 443 abuts against the case 21, and one end face of the clamping arm 442 abuts against the pressurizing mechanism 80 and the other end face abuts against the inner wall of the case 21.

Further, the above case 21 includes a movable cavity 215 penetrating along the direction of the first axis A1, a mounting opening 216 penetrating along the direction perpendicular to the first axis A1, and a stop portion 217 arranged within the mounting opening 216, and the step surface 443 abuts against the stop portion 217 to limit mounting of the inserting piece 44.

In the present embodiment, the above case 21 includes reinforcing ribs 218 arranged on the peripheral surface, the mounting opening 216 is located at the end of the case 21, and the reinforcing ribs 218 wrap around the outer side of the mounting opening 216, such that the area in which the inserting piece 44 is located is stronger and is less susceptible to damage.

In the present embodiment, the above plunger 88 moves linearly in a reciprocating manner along the first axis A1, and the pressurizing mechanism 80 also extends in the direction of the first axis A1, and exerts an acting force on the plunger 88 in the direction of the first axis A1.

Referring to FIG. 8 and FIG. 9, the above pump unit 4 includes a pump body 41, a water inlet valve assembly 7 arranged at the water inlet end 10, a first check valve assembly arranged between the water inlet valve assembly 7 and a pressure chamber 42, and a second check valve assembly arranged between the pressure chamber 42 and the water outlet end 20, the pressure chamber 42 is formed within the pump body 41, the first check valve assembly and the second check valve assembly are two identical check valve assemblies 6, a water inlet channel 101 is formed between the water inlet end 10 and the first check valve assembly 6, and a water outlet channel 102 is formed between the second check valve assembly 6 and the water outlet end 20.

The working principle of the hand-held high pressure washer 100 in the present embodiment is as follows: an external water source is connected to the water inlet end 10, the water flow passes through the water inlet channel 101 and then enters the pressure chamber 42, the plunger 88 extends into the pressure chamber 42, and the plunger 88 pressurizes water in the pressure chamber 42 under the effect of the motor assembly 1 and the transmission assembly 2, and the pressurized water flow flows through the water outlet channel 102 and is subsequently sprayed outwards from the water outlet end 20.

Specifically, in the first stage, the above plunger 88 moves away from the pressure chamber 42, the water inlet end 10 is open, the water inlet valve assembly 7 and the first check valve assembly are open, the second check valve assembly is closed, the water outlet end 20 is closed, and the water flow flows from the water inlet channel 101 into the pressure chamber 42; and in the second stage, the plunger 88 moves close to the pressure chamber 42 and pressurizes water in the pressure chamber 42, at this time, the first check valve assembly is closed and the second check valve assembly and the water outlet end 20 are open, and the water flow is sprayed outwards from the pressure chamber 42 through the water outlet channel 102.

In the present embodiment, the above water inlet channel 101 extends in the direction of the second axis A2, the water outlet channel 102 extends in the direction of the first axis A1, and the pressure chamber 42 extends in the direction of the first axis A1.

In the present embodiment, the water outlet direction of the above water outlet end 20 coincides with the extension direction of the first axis A1.

In the present embodiment, the projection of the above motor assembly 1 in the direction of the first axis A1 is not overlapped with the projection of the pump unit 4 in the direction of the first axis A1.

Referring to FIG. 8, the above pump body 41 is provided with a first sealing ring 103, and the case 21 is provided with a second sealing ring 104, and both the first sealing ring 103 and the second sealing ring 104 are sleeved to the periphery of the plunger 88 and are tightly attached to the periphery of the plunger 88, so as to achieve an efficient scaling effect.

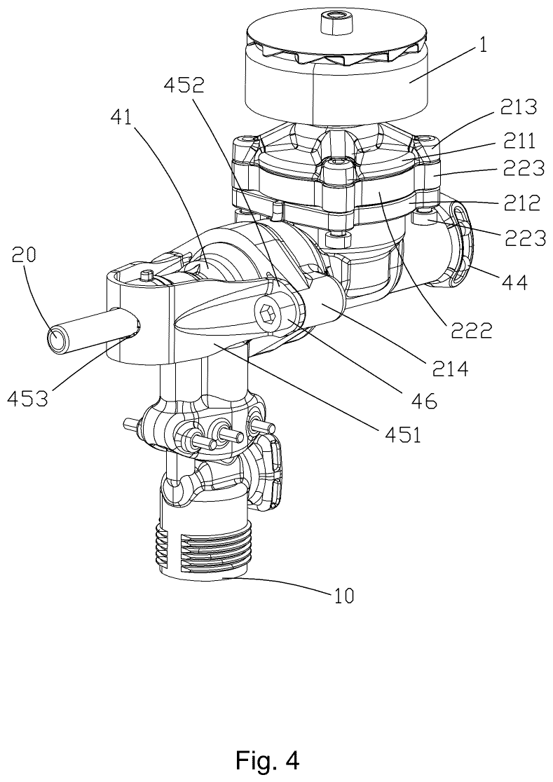

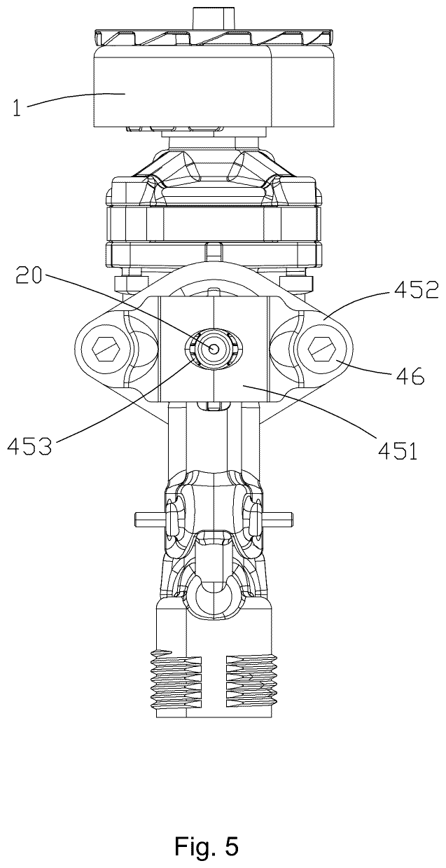

Referring to FIG. 3 to FIG. 5, the above pump unit 4 also includes a tensioning member 45 that fixes the pump body 41 to the case 21, the plunger 88 is located in the case 21 and extends to the pump body 41, the pump body 41 is made of plastic, the tensioning member 45 is made of metal, and the case 21 can be made of metal or plastic. By mounting the pump body 41 to the case 21 via the tensioning member 45, even when the pump body 41 is subjected to high pressure and impact, damage to the pump body 41 can also be effectively avoided, and at the same time, the requirements for higher output pressure and flow rate are also satisfied.

In the present embodiment, the above tensioning member 45 includes a U-shaped body 451 sleeved on the outer side of the pump body 41, a pair of mounting arms 452 extending outwards from the two ends of the U-shaped body 451, and a positioning opening 453 extending through the bottom wall of the U-shaped body 451, and the tensioning member 45 is fixed to the case 21 via the pair of mounting arms 452.

Further, the above case 21 includes a mounting base 214 corresponding to the mounting arm 452, and a fastening bolt 46 extends through the mounting arm 452 and the mounting base 214, so as to fix the tensioning member 45 to the case 21.

In the present embodiment, the above water outlet end 20 extends through the positioning opening 453.

In the present embodiment, the above U-shaped body 451 is arranged to be symmetrical about the first axis A1, and the first axis A1 extends through the positioning opening 453.

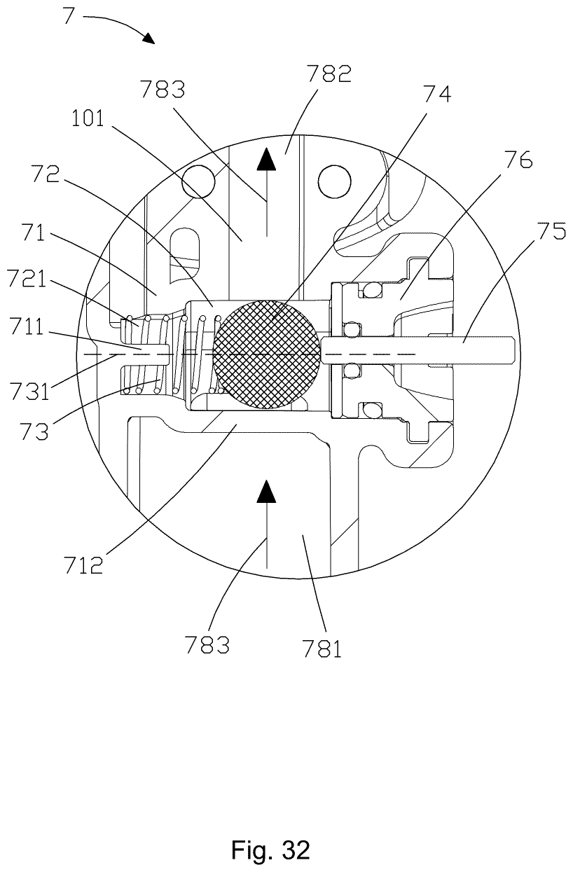

Referring to FIG. 32 to FIG. 34, the above water inlet valve assembly 7 includes a valve seat 71, a cavity 72 formed in the valve seat 71, a first elastic member 73 housed in the cavity 72, a valve ball 74 abutting against the first elastic member 73, a valve rod 75 abutting against the valve ball 74, and a supporting base 76 supporting the valve rod 75, and a water inlet channel 101 extends through the valve seat 71, and the water inlet channel 101 includes a water inlet side 781 in which water flows in, a water outlet side 782 in which water flows out, and a water flow direction 783 from the water inlet side 781 towards the water outlet side 782, and the water flow direction 783 approximately extends in a direction parallel to the second axis A2.

In the present embodiment, the above cavity 72 is located between the water inlet side 781 and the water outlet side 782; the first elastic member 73 extends along a direction 731 perpendicular to the water flow direction 783, the direction 731 extends approximately in a direction parallel to the first axis A1, and the first elastic member 73 and the valve rod 75 are located at two sides of the valve ball 74, and the valve ball 74 moves within the cavity 72.

In the present embodiment, the above water inlet valve assembly 7 has a first state in which water cannot pass through and the water inlet channel 101 is open, a second state in which water can pass through and the water inlet channel 101 is closed, and a third state in which water can pass through and the water inlet channel 101 is open. Specifically, the first state is a state in which no external water source is connected or no external unpressurized water source is connected, at this time, the valve ball 74 is subjected to no force and does not block the water inlet channel 101; the second state is a state in which an external pressurized water source is connected, at this time, the valve ball 74 moves under water pressure and blocks the water inlet channel 101; and the third state is a state in which the valve ball 74 is stressed to move and further the water inlet channel 101 is open.

In the present embodiment, the user can press the valve rod 75 and drive the valve ball 74 to move in the direction 731 perpendicular to the water flow direction 783, that is, the water inlet valve assembly 7 is switched from the second state to the third state, and in the third state, the valve rod 75 drives the valve ball 74 to compress the first elastic member 73, such that the valve ball 74 does not block the water inlet channel 101.

By designing a novel water inlet valve assembly 7, when an external pressurized water source is connected, the water pressure will push the valve ball 74 to automatically block the water inlet channel 101, and water inlet is controllable through a simple and low-cost structure; when the hand-held high pressure washer 100 needs to operate, the valve rod 75 is pressed to open the water inlet channel 101, the influence of the valve ball 74 on the flow of water flow is small, such that pressure loss of water pressure is small and the instantaneous flow is large, and the performance of the whole machine is effectively improved; and during the opening process, the valve ball 74 needs to be moved with a slightly large force at the beginning, when the water inlet channel 101 is open, the valve ball 74 is squeezed towards the side of the first elastic member 73 under the effect of water pressure, and the valve rod 75 may be pressed easily subsequently, and at the same time, the valve rod 75 is subjected to less force, and is not easy to break, thereby satisfying the operating requirement of the user for a greater amount of inlet water; in addition, the valve ball 74 rolls under the effect of water flow, the valve ball 74 is worn more evenly when in contact with the valve seat 71, and the adaptability is good, the fault tolerance rate is high, and the service life is also prolonged.

Referring to FIG. 32, the above valve seat 71 includes a guide pillar 711 protruding from the inner wall and a supporting seat 712 adjacent to the water inlet side 781, the guide pillar 711 extends into the cavity 72, and one end of the first elastic member 73 is sleeved to the guide pillar 711 and the other end abuts against the valve ball 74.

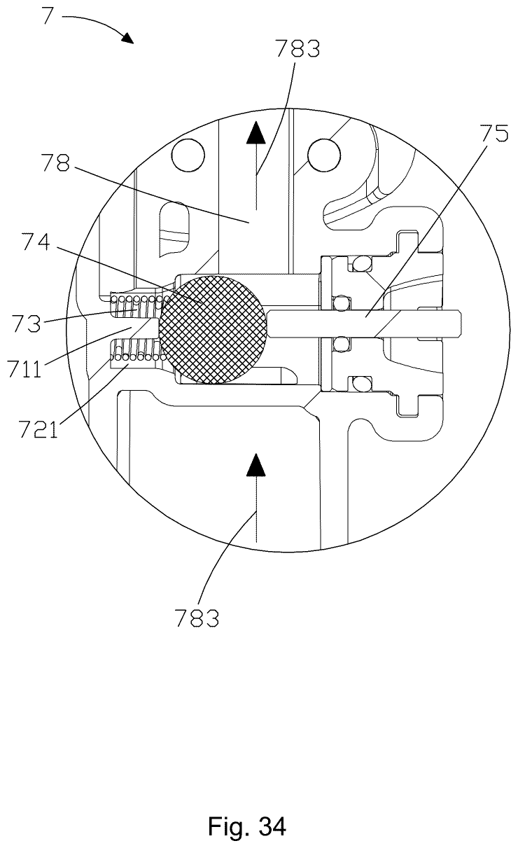

As shown in combination with FIG. 34, the above cavity 72 is provided with an inner cavity 721 accommodating the first elastic member 73, and a guide pillar 711 is located in the inner cavity 721, and in the third state, the valve ball 74 abuts against the guide pillar 711.

In the first state, the above valve ball 74 is supported on the supporting seat 712; in the process of switching from the first state to the second state, the valve ball 74 is detached from the supporting seat 712 under the effect of water pressure, moves in the water flow direction 783, and further closes the water inlet channel 101.

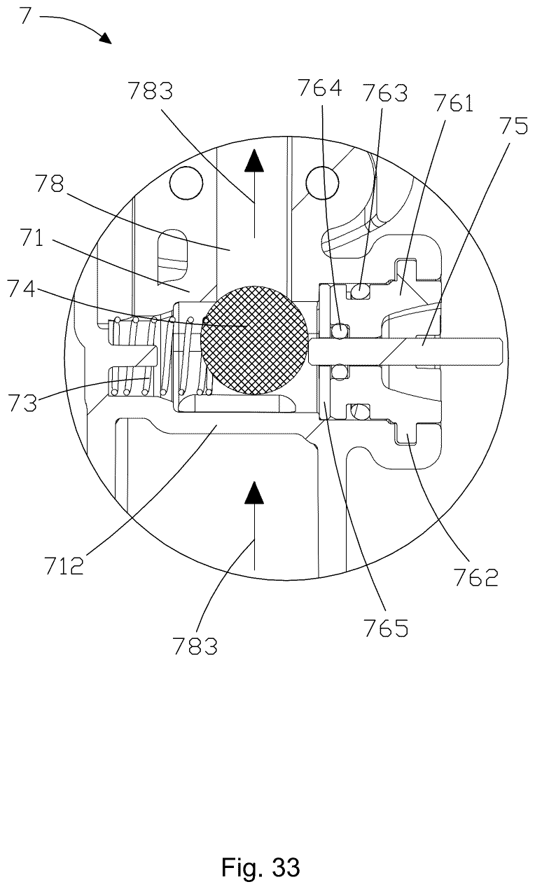

Referring to FIG. 33, the above supporting base 76 includes a base 761 mounted to the valve seat 71, a first protruding block 762 protruding outwards from the periphery of the base 761, a first sealing member 763 arranged between the periphery of the base 761 and the valve seat 71, a second sealing member 764 arranged between the inner circumference of the base 761 and the valve rod 75, and a gasket 765 arranged between the base 761 and the valve ball 74, wherein the valve rod 75 extends through the base 761 in a direction 731 perpendicular to the water flow direction 783, the first protruding block 762 is clamped in the valve seat 71, and the first sealing member 763 and the second sealing member 764 are arranged between the gasket 765 and the first protruding block 762.

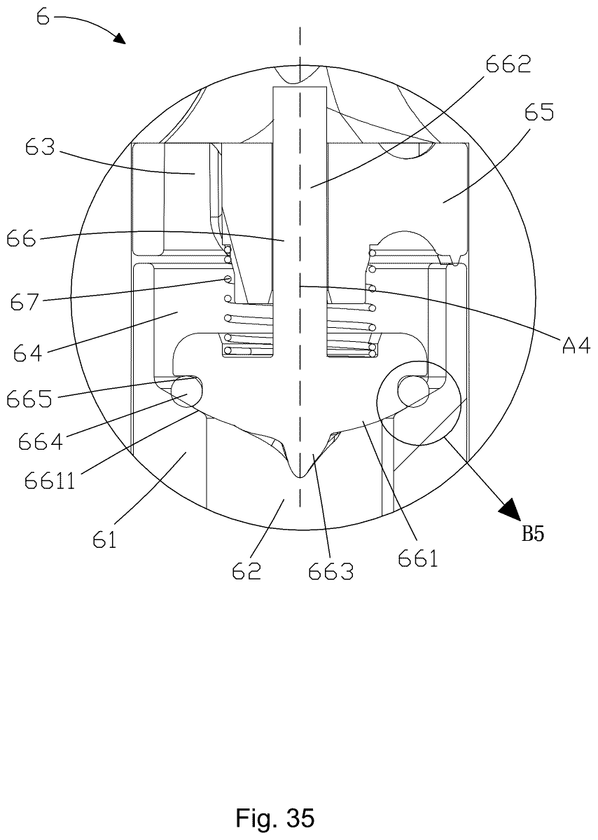

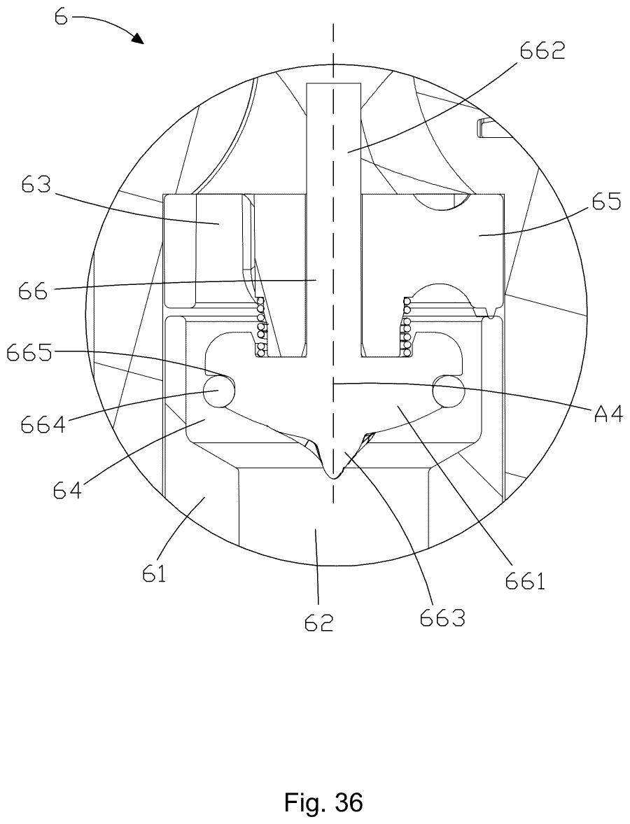

Referring to FIG. 35 and FIG. 36, the above check valve assembly 6 includes a valve body 61 provided with a water inlet 62 and a water outlet 63, a water flow channel 64 connected between the water inlet 62 and the water outlet 63, a bracket 65 mounted to the valve body 61, a valve core 66 arranged within the valve body 61, and a second elastic member 67 biasing the valve core 66, wherein the valve core 66 has a first position for blocking the water flow channel 64 and a second position for not blocking the water flow channel 64, and in the first position, the valve core 66 abuts against the valve body 61 for sealing.

In the present embodiment, the above valve core 66 includes a head 661 abutting against the valve body 61, a rod portion 662 connected to the head 661, and a spiral feature 663 arranged in the head 661, wherein the spiral feature 663 is arranged at an end face of the head 661 close to the water inlet 62, and the spiral feature 663 and the rod portion 662 are located on two opposite sides of the head 661. By arranging the spiral feature 663 in the head 661 of the valve core 66, the water source entering from the water inlet 62 flows through the spiral feature 663, to drive the valve core 66 to rotate, such that in the process of contact between the valve core 66 and the valve body 61, the head 661 adaptively pivots, with high consistency of the entire surface of the head 661 and more uniform abrasion, thereby greatly prolonging the service life; in addition, the spiral feature 663 is integrally formed in the head 661 with a simple structure and low cost.

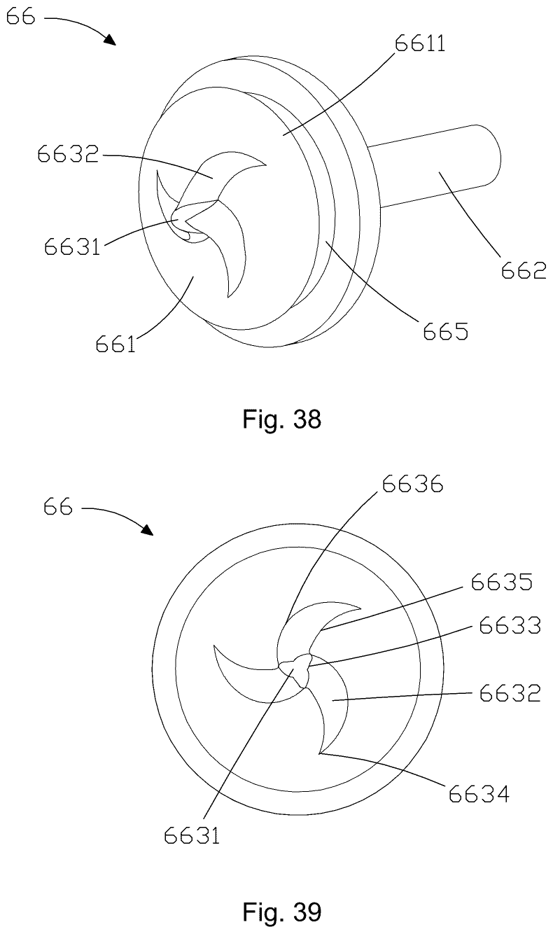

Referring to FIG. 38 to FIG. 40, the above spiral feature 663 includes a guide head 6631 arranged in the center of the head 661 and a spiral portion 6632 extending spirally from the guide head 6631 towards the edge of the head 661, the guide head 6631 protrudes from the end face of the head 661 towards the water inlet 62, and the top of the guide head 6631 is in the shape of a round head; and the number of spiral portions 6632 is multiple, and the multiple spiral portions 6632 are spaced apart around the guide head 6631.

In the present embodiment, the above spiral portion 6632 includes a proximal end 6633 close to the guide head 6631 and a distal end 6634 away from the guide head 6631, wherein the proximal end 6633 gradually narrows towards the distal end 6634 and the ends of the distal end 6634 converge at a point.

Further, the above valve core 66 has a fourth axis A4, the fourth axis A4 extends through the guide head 6631 and the guide head 6631 is symmetrically distributed about the fourth axis A4.

Still further, in the direction of the fourth axis A4, the above guide head 6631 is closer to the water inlet 62 compared to the spiral portion 6632, such that the water source entering from the water inlet 62 flows through the guide head 6631 and the spiral portion 6632 in sequence, to further drive the entire valve core 66 to rotate, and make the abrasion of the valve core 66 more uniform.

In the present embodiment, the above head 661 includes a contact surface 6611 abutting against the valve body 61, the spiral feature 663 is arranged on the inner side of the contact surface 6611, and the projection of the spiral feature 663 in the direction of the fourth axis A4 is not overlapped with the projection of the contact surface 6611 in the direction of the fourth axis A4.

In the present embodiment, the above second elastic member 67 is a spring, one end of the second elastic member 67 abuts against the head 661, and the other end abuts against the bracket 65, and the rotational direction of the valve core 66 is the same as the rotational direction of the second elastic member 67, and the valve core 66 and the second elastic member 67 both rotate leftwards, therefore, in the rotational process of the valve core 66, the abrasion caused by contact between the end of the second elastic member 67 and the surface of the head 661 is less, thereby being conducive to prolonging the service life of the valve core 66.

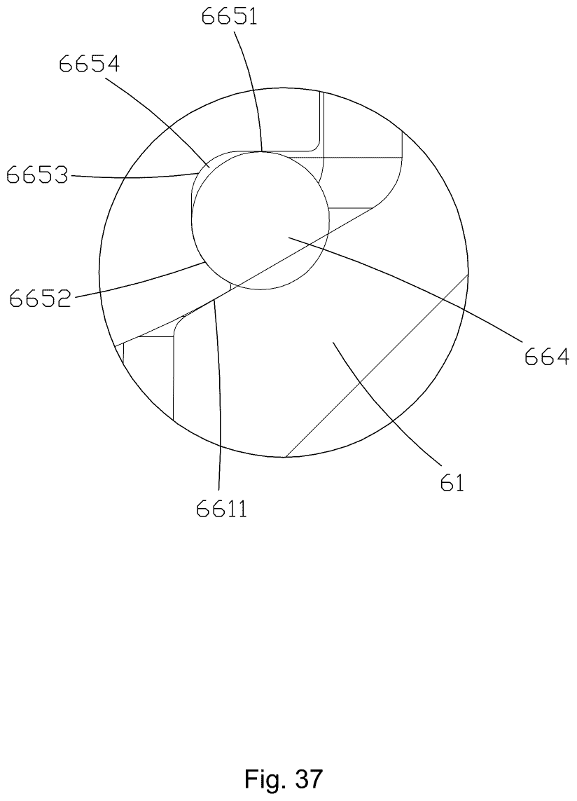

Referring to FIG. 35 to FIG. 37, the above valve core 66 further includes a third sealing ring 664 mounted on the head 661, and in a first position, the third sealing ring 664 abuts against the surface of the valve body 61. By arranging the third sealing ring 664 at the head 661 of the valve core 66, the third sealing ring 664 is in contact with the surface of the valve body 61 and forms a seal, thereby further improving the sealing effect of the check valve assembly 6.

In the present embodiment, the above head 661 includes an accommodating cavity 665 recessed from the contact surface 6611, the third sealing ring 664 is housed in the accommodating cavity 665, and the accommodating cavity 665 includes a first wall surface 6651 away from the contact surface 6611, a second wall surface 6652 adjacent to the contact surface 6611, and a third wall surface 6653 connected between the first wall surface 6651 and the second wall surface 6652, and the first wall surface 6651, the second wall surface 6652 and the third wall surface 6653 together form the accommodating cavity 665.

In the present embodiment, the above second wall surface 6652 is a curved surface, and the second wall surface 6652 is attached to the peripheral surface of the third sealing ring 664.

In the second position, the above third sealing ring 664 is spaced apart from the third wall surface 6653 to form a buffer cavity 6654; and in the first position, the third sealing ring 664 squeezes the valve body 61 and deforms, and the third sealing ring 664 extends into the buffer cavity 6654 to improve the sealing effect of the third sealing ring 664.

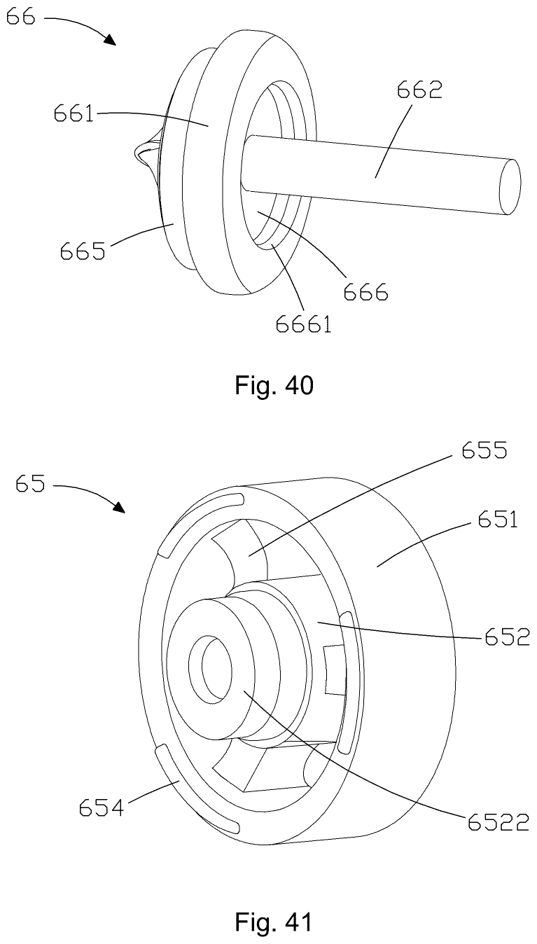

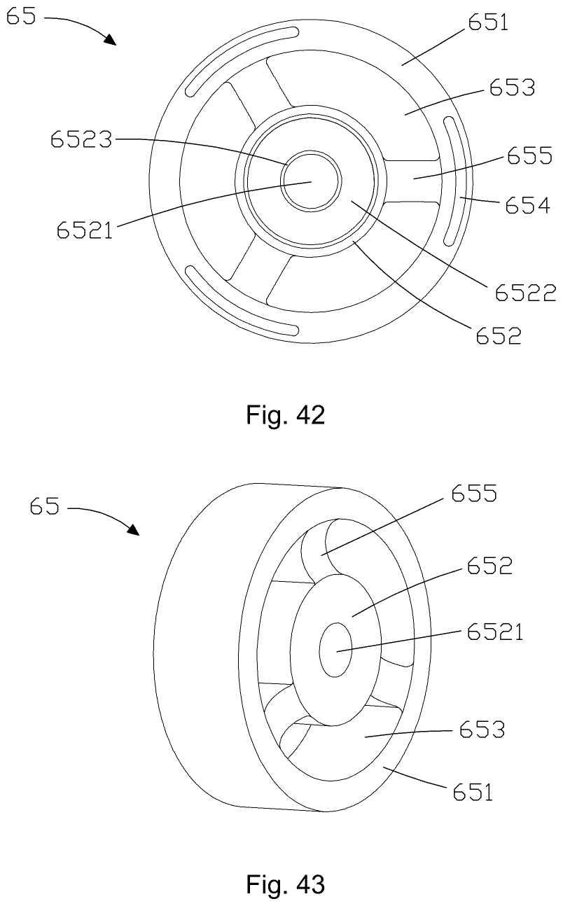

Referring to FIG. 40 to FIG. 43, the above valve core 66 is connected to a bracket 65, the bracket 65 includes a bracket body 651, a base body 652 arranged on an inner side of the bracket body 651, a water channel 653 arranged between the base body 652 and the bracket body 651, a second protruding block 654 extending from an end face of the bracket body 651 towards the head 661 and a bracket arm 655 connecting the base body 652 and the bracket body 651, the base body 652 is provided with a penetrating hole portion 6521, and the rod portion 662 is supported within the hole portion 6521 and moves along the hole portion 6521.

Further, the above base body 652 includes a bracket column 6522 extending from an end face towards the head 661, the valve core 66 includes a cavity 666 recessed from an end face of the head 661 close to the bracket 65, and one end of the second elastic member 67 is sleeved to the periphery of the bracket column 6522 and the other end of the second elastic member 67 is accommodated in the cavity 666.

Still further, the end of the above hole portion 6521 and the end of the above cavity 666 are provided with chamfers 6523, 6661, respectively.

As shown in combination with FIG. 36, the above second protruding block 654 abuts against the valve body 61, multiple bracket arms 655 and second protruding blocks 654 are arranged, and the positions of the plurality of second protruding blocks 654 correspond to the positions of the plurality of bracket arms 655.

In the present disclosure, through arranging a pressurizing mechanism at the end of the plunger away from the pump unit, the plunger can store energy for the pressurizing mechanism in the half cycle when the plunger does not do work, and the stored energy is released to the plunger in the half cycle when the plunger does work, thereby greatly improving the working efficiency of the hand-held high pressure washer; in addition, the pressurizing mechanism is capable of compensating for the torque of the plunger, such that higher output pressure and flow rate can also be obtained when the performance of the motor assembly is low, thereby effectively reducing the cost of the whole machine. The present disclosure is not limited to the specific embodiments described above. Those skilled in the art can easily understand that there are also many alternatives to the hand-held high pressure washer of the present disclosure without departing from the principles and scope of the present disclosure. The protection scope of the present disclosure is subject to the contents of the claims.

1. A hand-held high pressure washer comprising:
a pump unit having a water inlet end and a water outlet end;
a motor;
a transmission assembly connected to the motor; and
a plunger driven by the transmission assembly; the transmission assembly comprising a case, the plunger at least partially arranged in the case and extending into the pump unit, the motor driving the transmission assembly to drive the plunger to move in a reciprocating manner within the pump unit,
wherein the transmission assembly comprises a pressurizing mechanism abutting against the plunger, the pressurizing mechanism is located in the case, and the pump unit is provided with a pressure chamber accommodating the plunger, the pressurizing mechanism and the pressure chamber are respectively located at two ends of the plunger, the pressurizing mechanism has a first stage for storing energy and a second stage for releasing energy, in the first stage, the transmission assembly drives the plunger to store energy for the pressurizing mechanism; and in the second stage, the transmission assembly drives the plunger to pressurize a water flow of the pressure chamber, and the pressurizing mechanism exerts an acting force on the plunger in the direction towards the pressure chamber.

2. The hand-held high pressure washer according to claim 1, wherein the plunger comprises a guiding rod protruding from an end of the plunger towards the pressurizing mechanism, the transmission assembly further comprises an inserting piece mounted in the case, the pressurizing mechanism is a spring, one end of the spring is sleeved in the guiding rod, and another end of the spring abuts against the inserting piece.

3. The hand-held high pressure washer according to claim 2, wherein the inserting piece comprises a base plate, a clamping arm connected to the base plate and a step surface arranged at a connecting position between the base plate and the clamping arm, the step surface abuts against the case, one end face of the clamping arm abuts against the pressurizing mechanism, and the another end face of the clamping arm abuts against an inner wall surface of the case.

4. The hand-held high pressure washer according to claim 3, wherein the inserting piece further comprises an opening extending through the base plate, and the opening is at least partially exposed to an exterior of the case.

5. The hand-held high pressure washer according to claim 3, wherein the clamping arm is U-shaped and has two arms which are parallel to each other, and the pressurizing mechanism abuts against the two arms of the clamping arm.

6. The hand-held high pressure washer according to claim 3, wherein the case comprises a movable cavity extending through the case in a direction of a first axis, a mounting opening penetrating in a direction perpendicular to the first axis, and a stop portion arranged within the mounting opening, wherein the pressurizing mechanism is accommodated in the movable cavity, and the step surface extends through the mounting opening and abuts against the stop portion.

7. The hand-held high pressure washer according to claim 6, wherein the case further comprises reinforcing ribs arranged on a peripheral surface, the mounting opening is arranged at an end of the case, and the reinforcing ribs wrap around an outer side of the mounting opening.

8. The hand-held high pressure washer according to claim 1, wherein the transmission assembly further comprises a reducing mechanism connected to the motor and an output member connected to the reducing mechanism, the output member drives the plunger to move in the reciprocating manner; the reducing mechanism comprises planetary teeth connected to the motor and a toothed ring engaged with the planetary teeth, and a fastener extends through the case and the toothed ring, to lock the case and the toothed ring.

9. The hand-held high pressure washer according to claim 8, wherein the toothed ring comprises a toothed ring body engaged in the planetary teeth, a lip protruding axially from an end face of the toothed ring body, and a clamping column protruding radially outwards from a periphery of the toothed ring body, wherein the lip abuts against an inner side of the case, and the fastener extends through the case and the clamping column, so as to fix the case and the toothed ring.

10. The hand-held high pressure washer according to claim 1, wherein the plunger comprises a first axis, the motor comprises a second axis, the first axis is perpendicular to the second axis, and in the first stage, the water inlet end is open and the water outlet end is closed, and the plunger moves away from the pressure chamber; and in the second stage, the water inlet end is closed and the water outlet end is open, and the plunger moves close to the pressure chamber.

11. A hand-held high pressure washer comprising:
a casing;
a motor, a plunger, and a pump unit installed in the casing, the pump unit comprising a water inlet end and a water outlet end connected to each other, and a pressure chamber located between the water inlet end and the water outlet end, and the plunger extending into the pressure chamber, the motor driving the plunger to move in a reciprocating manner in the pressure chamber so as to pressurize external water flow entering from the water inlet end and then spray the water flow outwards from the water outlet end;
wherein the pump unit is a single-cylinder pump, the transmission assembly comprises a pressurizing mechanism abutting against the plunger, the pressurizing mechanism and the pressure chamber are located at two ends of the plunger; the plunger moves linearly in the reciprocating manner along a first axis, and the pressurization mechanism extends in a direction of the first axis and exerts a force on the plunger in the direction of the first axis.

12. The hand-held high pressure washer according to claim 11, further comprising a battery pack that supplies energy to the motor,
wherein the casing comprises a main body portion and a gripping portion extending from an end of the main body portion, the main body portion receives the motor, the plunger, and the pump unit,
the battery pack is detachably mounted on the grip portion.

13. The hand-held high pressure washer according to claim 11, wherein the pump unit comprises a pump body, a first check valve assembly located between the water inlet end and the pressure chamber, and a second check valve assembly located between the water outlet end and the pressure chamber;
a water inlet channel is formed between the water inlet end and the first check valve assembly, and a water outlet channel is formed between the second check valve assembly and the water outlet end.

14. The hand-held high pressure washer according to claim 13, wherein the pump unit further comprises a water inlet valve assembly located between the water inlet end and the first check valve assembly, the water inlet channel is blocked under a pressure of a water source when the water inlet valve assembly is configured to be connected to an external pressurized water source.

15. The hand-held high pressure washer according to claim 14, wherein the water inlet valve assembly comprises a valve seat, a cavity formed in the valve seat, a elastic member housed in the cavity, a valve ball abutting against the elastic member, a valve rod abutting against the valve ball,
the elastic member and the valve rod are located on both sides of the valve ball, and the valve ball moves within the cavity to open or close the water inlet channel.

16. The hand-held high pressure washer according to claim 13, wherein each of the first check valve assembly and the second check valve assembly comprises a valve body provided with a water inlet and a water outlet, a valve core arranged within the valve body, and an elastic member biasing the valve core;
the valve core comprises a head abutting against the valve body and a spiral feature arranged in the head, the spiral feature is arranged at an end face of the head close to the water inlet.

17. The hand-held high pressure washer according to claim 16, wherein the valve core further comprises a sealing ring mounted on the head, the sealing ring abuts against the valve body.

18. A hand-held high pressure washer comprising:
a casing;
a motor, a transmission assembly, a plunger, and a pump unit installed in the casing, the pump unit comprising a water inlet end and a water outlet end connected to each other, and a pressure chamber located between the water inlet end and the water outlet end, the transmission assembly is connected between the motor and the plunger, the plunger extending into the pressure chamber, the motor driving the plunger by the transmission assembly to move in a reciprocating manner in the pressure chamber so as to pressurize external water flow entering from the water inlet end and then spray the water flow outwards from the water outlet end;
wherein plunger comprises a first axis, the motor comprises a second axis, the first axis is perpendicular to the second axis;
the transmission assembly comprises a pressurizing mechanism abutting against the plunger, the pressurizing mechanism and the pressure chamber are located at two ends of the plunger; the water inlet end and the motor are located on opposite sides of the first axis, and the pressurizing mechanism and the water outlet end are located on opposite sides of the second axis.

19. The hand-held high pressure washer according to claim 18, wherein the transmission assembly comprises a case, the pump unit comprises a pump body and a tensioning member that fixes the pump body to the case;
the plunger is located in the case and extends to the pump body;
the pump body is made of plastic, the tensioning member is made of metal.

20. The hand-held high pressure washer according to claim 19, wherein the tensioning member comprises a U-shaped body sleeved on an outer side of the pump body, a pair of mounting arms extending outwards from two ends of the U-shaped body, and a positioning opening extending through a bottom wall of the U-shaped body, and the pair of mounting arms is fixed to the case, the water outlet end extends through the positioning opening.
